(19) United States
(12) Patent Application Publication
(10) Pub. No.: US 2008/0303811 A1
(43) Pub. Date: Dec. 11, 2008

(54) Virtual Professional

(75) Inventor: Andrew S. Van Luchene, Santa Fe, NM (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/759,745

(22) Filed: Jun. 7, 2007

(51) Int. Cl. G06T 15/00

(52) U.S. Cl. 345/419

(57) ABSTRACT

A virtual environment including a plurality of virtual professionals capable or providing goods and services to players in the virtual environment is described. The goods and services may be relevant to the real world, the virtual world, or both. Single-use avatars whose availability is limited and which are configured to protect the anonymity of the player controlling the single-use avatar may be used when anonymity is desired. Queues may be used to schedule appointments with virtual professionals.

### BACKGROUND

Virtual Environments which are accessible to multiple subscribers via a server are well known. For example, hundreds of thousands of players access games known as massive multi player online games (MMOGs). Players of these games customarily access a game repeatedly (for durations typically ranging from a few minutes to several days) over given period of time, which may be days, weeks, months or even years. The games are often constructed such that players pay a periodic subscription price (e.g., $15 per month) rather than, or in addition to, paying a one time purchase price for the game. Often, though not necessarily, these games have no ultimate “winner” or “winning goal,” but instead attempt to create an enjoyable playing environment and a strong player community. Virtual communities like Linden Lab's “Second Life” provide a three-dimensional metaverse in which people (who may or may not pay a fee for the right to access the metaverse) create avatars that are able to interact with other avatars as well as the local environment. It would be advantageous to provide improved methods and apparatus for increasing the enjoyment and/or longevity of these virtual environments.

### BRIEF DESCRIPTION OF THE DRAWINGS

FIG. 1 is a block diagram depicting a system 10 according to an embodiment of the present disclosure.

### DETAILED DESCRIPTION

Massive multi player online games (MMOGs) or massive multi-player role-playing games (MMORPGs) are computer game which are capable of supporting hundreds, thousands, or millions of players simultaneously. Typically, this type of game is played in a giant persistent world where the game continues playing regardless of whether or not real players are logged in. Players commonly access these games through a network such as the Internet, and may or may not be required to purchase additional software or hardware in order to play the game. Such networks allow for people all over the world to participate and interact with each other in a virtual environment. The present disclosure provides systems and methods which contribute to the evolution and longevity of such a game. According to various embodiments, the present disclosure provides virtual professionals for use in a virtual environment.

Accordingly, the present disclosure provides various methods and systems which are suitable for use in a virtual metaverse. As used herein, the term “virtual” includes the concept “in a computer-generated environment or other intangible space.” Further more, a “metaverse” includes a collection of online virtual environments which are accessible to one or more players of one or more online games or communities. In some embodiments, certain areas in a metaverse may be restricted to some players. Examples of metaverses include Massive Multi Player Online Video Game (MMPOVGs) such as World of Warcraft and virtual communities such as Second Life.

MMPOVGs (sometimes referred to as Massive Multi Player Online Role Playing Games MMPORPGs) include video games and virtual environments that are provided by and accessed via at least two video game consoles connected to a Video Game Central Server via a network such as an internet or intranet, or as part of a peer-to-peer network including at least two Video Game Consoles. In some embodiments, players create and/or control characters that may interact with each and their surrounding virtual environment in a Metaverse that is stored on the Video Game Central Server and/or the Video Game Consoles.

According to numerous embodiments, in order to access a particular, metaverse, virtual environment, or game, a video game console Video Game Central may be in electronic communication with a video game server. A video game server may include a CPU, memory, and permanent or temporary storage and be in electronic communication with multiple players via multiple video game consoles. As such, the plurality of players are able to interact with each other as well as the metaverse by accessing the video game server via their video game consoles.

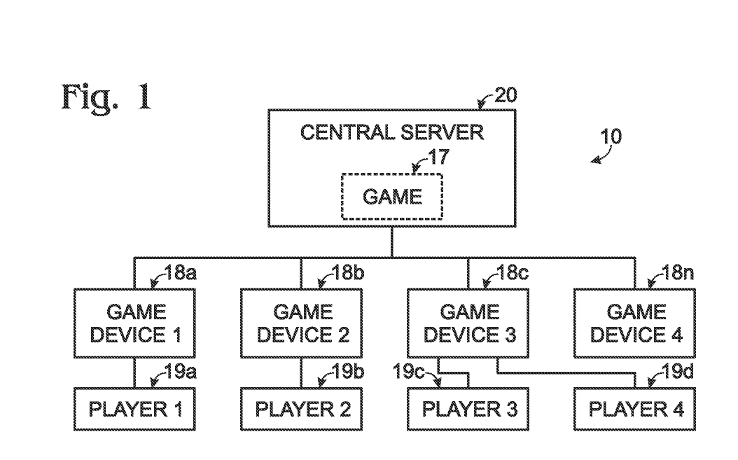

Referring to FIG. 1, a network system 10 according to one embodiment includes a central server 20 in communication with a plurality of video game consoles or playing units 18. Those of ordinary skill in the art will appreciate that any number of video game playing units may be in communication with the central server. Typically, the number of video game playing units changes at various times as players join games and as players stop playing games. Similarly, more than one server may operate to coordinate the activities of the video game playing units, as is well known in the art.

Central server 20 may comprise any computing device (e.g., one or more computers) capable of communicating with other computing devices. The server 20 typically comprises a processor which is in communication with a storage device, such as an appropriate combination of RAM, ROM, hard disk, and other well known storage media. Central server 20 may comprise one or more personal computers, web servers, dedicated game servers, video game consoles, any combination of the foregoing, or the like.

Each video game device 18 may comprise any device capable of communicating with central server 20, providing video game information to a player, and transmitting the player's desired actions to the central server. Each video game device typically comprises a processor which is in communication with a storage device, such as an appropriate combination of RAM, ROM, hard disk, and other well known storage media. Suitable video game devices include, but are not limited to, personal computers, video game consoles, mobile phones, and personal data assistants (PDAs).

Some or all of video game 17 can be stored on central server 20. Alternatively, some or all of video game 17 may be stored on the individual video game devices 18. Typically, the video game devices are able to communicate with one another. Such communication may or may not be facilitated by central server 20. Accordingly, a player 19a accessing video game 17 via game device 18a may be able to play with a player 19b accessing video game 17 via game device 18b. As shown, it may be possible for multiple players (e.g. 19c, 19d) to access central server 20 via the same game device (e.g. 18c).

Regardless of whether video game 17 is stored on central server 20 or video game devices 18, server 20 is typically configured to facilitate play of the game between multiple game players.

The games and metaverses wherein these games take place are typically accessible to player via a video game console. For the purposes of the present disclosure, “video game consoles” include devices comprising a CPU, memory, and optional permanent storage residing at a player location that can allow for the playing of video games. Examples include, home PCs, Microsoft Xbox, and Sony Playstation, Wii, Playstation portable, etc. Dedicated video game consoles may be useful for only playing video games, while multifunctional video game consoles, such as personal computers, PDA's and the like may be useful for performing multiple tasks including, but not limited to playing video games.

As stated above, a particular metaverse may include one or more virtual or game environments. For the purposes of the present disclosure the terms “virtual environment,” “game environment” and the like include a region, sub-region or area of a metaverse such as a country, city, era, building, etc., which is in some way recognizably different from another region, sub-region, or area of the metaverse.

It will be understood that a “game” as used herein need not be a “game” in the traditional sense of a competition in which a winner and/or loser is determined, but rather that the term “game” incorporates the idea of the metaverse regardless of the intended purpose. Accordingly, both World of Warcraft and Second Life would be referred to as games for the purposes of the present disclosure. Moreover, a person or entity who enters the metaverse in order to conduct business, tour the metaverse, or simply interact with others or the virtual environment, with or without competing against another entity is still considered to be “playing a game.”

In certain embodiments, players and/or other entities enter into contracts that define the terms and conditions or expectations of such agreements/contracts. Exemplary methods to create such agreements are disclosed in U.S. patent application Ser. Nos. 11/279,991, 11/611,050, 11/355,232, and 11/624,662, each of which is hereby incorporated by reference.

Exemplary methods to secure a contract using a credit card are disclosed in U.S. patent application Ser. Nos. 11/279,991, 11/611,050, 11/355,232, and 11/624,662, each of which were incorporated by reference above.

Exemplary methods to provide for payment of a fee or to otherwise modify a position of an item within a queue are disclosed in U.S. patent application Ser. Nos. 11/462,621 and 11/611,024, each of which is hereby incorporated by reference.

Exemplary methods to provide attachment of notes into documents and/or associate notes with documents, or words, or other data are disclosed in U.S. patent application Ser. Nos. 11/690,095, 11/697,480, and 11/697,486, each of which is hereby incorporated by reference.

According to an embodiment, a virtual environment is configured to provide a central or other certification service or process for Virtual Professionals, e.g., including, but not limited to: accountants, CPA's, doctors, consultants, e.g. financial planners, lawyers, e.g., tax or patent attorneys, and psychologists or psychiatrists to register and conduct business within a virtual game environment. For the purposes of the present disclosure, the term “virtual professional” includes any individual that may or may not be licensed (in the real or virtual world) to provide free or for fee services. Examples include, but are not limited to; real, virtual or fictitious Doctors, Psychiatrists, Psychologists, Financial Planners, Lawyers, Dentists, Priests, Counselors, Private or other Investigators, and the like. In general, the terms “Professional,” “Virtual Professionals,” and “Professionals” shall have corollary meanings.

According to this embodiment, a Virtual Professional may register his credentials and specialties or perform any other actions to obtain a virtual license, if required, or available, in the virtual environment. Credential or specialty registration may take place any time including, before, after or during registration to conduct business in the virtual world, should such registration (e.g. an application for a business license) be required by the virtual environment. For the purposes of the present disclosure, a “virtual license” includes a registration, permit or permission for a Virtual Professional to practice in his field of specialty within a virtual or game environment. Issuance of a virtual license may first require verification of a virtual or real world license, Virtual Professional membership, degrees, and/or other credentials. Virtual Licenses may provide broad or narrow authority or permissions, which may include restrictions on time, era, game, or class of player, player character, fees, free structures or types, Client and/or account types. Furthermore, a “certification service” may include the process or processes by which professionals can be accredited to practice in their field of specialty within a game or virtual-world environment. Certification services may be manual—requiring the professional to submit an application and/or other credentials to a certification agency and/or panel—or automatic—in which case the certification process is initiated by factors including, but not limited to: a player's game stage, era, accumulated hours, user feedback, ranking, etc. A “credential” may include any qualification, achievement, personal quality or aspect of a person's background that may be used to authorize that person for certain roles and/or duties. In the case of a Virtual Professional, a credential may be issued by a real- or virtual-world licensing agency and may or may not be required in order to provide a virtual service.

Once any required approval to conduct business is received by the necessary entity, (e.g. a virtual environment administrator or other authorized approval mechanism or governing body) the Virtual Professional can create a player character or avatar and can set up one or more virtual locations where player characters or other individuals, i.e., clients can interact with the Virtual Professional in order to receive services from the Virtual Professional. It will be appreciated, of course, that environments may vary as to whether or not approval, licensure, registration, or any combination thereof is required. For the purposes of the present disclosure, the term “client” includes any real or virtual: person, player, player character or other third party that seeks, requests or obtains the services of a Virtual Professional. Clients may be players, player characters or any third party.

In some cases, clients are required to pay with virtual or real currency to enter into a chat or other communications appointment with the Virtual Professional for a fixed or variable fee for a block of time or number of appointments. For the purposes of the present disclosure, a chat session includes the synchronous or asynchronous services by which players and professionals may interact. Chat sessions may be textual, audio and/or visual, and may serve as either the primary or auxiliary means of client-professional contact. Additionally, chat sessions may be conducted within or outside of the virtual or game environment, or in some combination thereof.

Payment for services includes, but is not limited to: immediate or deferred billing, one time or a series of payments, real or virtual currency, trade or barter system. For example, a Client may pay a doctor for services by providing in-game objects or attributes, loans or other credit instruments, including, for example, real or virtual credit cards. In other cases, Clients may be required by their real world insurance company, including health insurance, business liability insurance, medical malpractice insurance (etc. etc. etc.) to attend appointments and/or training sessions with a Virtual Professional. In such cases, payment may be made by the insurance company either directly or indirectly to the Virtual Professional's account.

In certain embodiments, Virtual Professionals may offer their services for free or for a fee. In the cases that fee is charged, such fees may be collected directly from the player or player character or in certain cases, such fees may be collected by the game server, video game environment, or a third party financial services company. Such fees may be charged in real or virtual currencies or a combination of these and/or through a debt or other financial instrument, for example, a virtual credit card. The game server can collect a fee in virtual or real currency and give all or a percentage of that fee to the Virtual Professional.

In one embodiment, Clients or Virtual Professionals may either choose or may be required to use anonymous names or other identifiers. In many virtual environments, players or player characters already use aliases or other methods to conceal their actual identity. However, during the course of game play, there is often communication between multiple players over time and a player's actual identity may become known. It is therefore desirable to offer an option for the system to create a new alias that can be used temporarily, generally or exclusively to identify a Client or Virtual Professional when anonymity is required or desirable. In those instances, the disclosed invention may provide a Client or Virtual Professional with an anonymous alias and/or avatar. The anonymous alias and/or avatar may be generated automatically, or at the client or virtual professional's request. Furthermore, the client or virtual professional may or may not be allowed to provide input regarding the anonymous alias or avatar that is generated. When enabled, such generated aliases or avatars are used and displayed instead of actual names or the primary avatar or Client name. In this fashion, neither the Client nor the Virtual Professional will be made aware of the other's actual or customary names, unless such information is released by the owner of such information and/or is released for other reasons, such as by an order of a real or virtual court or other governing entity. For the purposes of the present disclosure, the term “anonymous name” includes any name and/or personal information that may be used to disguise the true identity of players or player characters and/or any one or more third parties. Anonymous names may be utilized on a short-term basis—as in the case of a temporary alias—or on a longer-term basis—as in the case of continuing professional appointments.

In some cases, the anonymous name or alias may be a temporary alias. For the purposes of the present disclosure, a “temporary alias” includes a class of avatars or names and/or handles designed for short-term or limited use by a player or player character or other third parties, including, for example, one or more virtual professionals. For example, temporary aliases may be designed or selected by the player or player character or other third party to disguise their own likeness, and may include privacy and safeguarding measures to prevent the player or player character's or other third party's true identity from being revealed. In the case of appointments with virtual professionals, temporary aliases may be used by a player or player character to interview the virtual professional without the loss of anonymity.

According to one embodiment, single use avatars can be generated. For the purposes of the present disclosure, a “single use avatar” includes a class of avatars designed for short-term or other limited or specified use by a player or player character and or a third party, e.g., a Virtual Professional. For example, single-use avatars may be designed by the player or player character to disguise their own likeness, and may include privacy and safeguarding measures to prevent the player or player character's true identity from being revealed. In the case of appointments with virtual professionals, single-use avatars may be used by a player or player character to interview the virtual professional without the loss of anonymity. In some cases, single use avatars act like single use credit card numbers, allowing a player to shield his identity during a single appointment or interaction in a virtual world. Single use avatars may be provided for free for a fee. For example, in some embodiments, players can pay a fee to the game server to purchase a single use avatar.

In some embodiments, Virtual Professionals or Clients may be required by the game server to use a single use avatar during consultation appointments. In certain embodiments, in the event that a single use avatar is used, the system may keep a record of all transactions conducted by the single use avatar. By maintaining such records, the system can maintain continuity of all interactions with the same anonymous person. For example, if Client A, visits Virtual Professional A for a dozen appointments, Client A and or Virtual Professional A, may choose to use the same or different single use avatars. In any case, the system would retain records that, while maintaining anonymity of either the Client or the Virtual Professional, would permit a review of the entire case. In the event of a dispute, and if all parties agree or are otherwise forced to disclose such information, such a system would permit the review of all appointments and/or, provided authorized access is granted or is ordered by a court of competent jurisdiction, the identities of the parties involved.

According to a further embodiment, single use avatars and aliases may also be used by any supporting personnel and/or acquaintances of either the Client or the Virtual Professional, for example, by nurses or paralegals.

In the case that one or more anonymous names are used, the system may record both the real and anonymous name(s) within a database designed for such purposes. This information may be encrypted to safeguard against unauthorized access or use of such records or information. Access to this information may be necessary or desirable in the event that a dispute or other issue, e.g., payment issues, arise(s) out of or relating to the services rendered by a Virtual Professional or a failure to pay by a Client, or any other issues or problems that may arise from time-to-time.

In yet another embodiment, the system initially presents or displays anonymous names for either the Client or the Virtual Professional or both and, at some subsequent point; the system may reveal the real name of one or the other individuals. This option permits each party, i.e., the Client and the Virtual Professional, to conduct an initial dialog or interview to see if they are compatible with each other, without having to first reveal their true identity. Then, if each party agrees, one or the other's or both true identity may be revealed. Such revelation may occur only in a secure location, i.e., a location where other players, player characters, Clients or Virtual Professionals or any other third party cannot see or otherwise determine (in real time or after the fact) what has transpired and/or who has entered the room or location.

In some cases, an existing or potential Client or Virtual Professional may not want to be seen visiting or providing services at any particular location, e.g., a doctor's office. To address this concern, the system may include or offer an option to permit an existing or potential Client or Virtual Professional to secretly transport them to a given location. In this case the Client or Virtual Professional can select an option to transport to a particular location and the system will transport the Client or Virtual Professional to the desired location, e.g., a private waiting room or doctor's office or lobby. Communications and services can be then conducted or delivered in private without the probability of falling prey to prying eyes or those that might use such information for the benefit of themselves or to the detriment of the Client, Virtual Professional or the virtual environment or other entities. Such transportation option may apply generally in a virtual environment and does not necessarily apply only to Clients or Virtual Professionals, i.e., any player character or NPC or other virtual person may wish to make use of such anonymous transportation for their own reasons.

In some cases, transportation may involve the use of a “secret entry” or “secret exit.” For the purposes of the present disclosure, a “secret entry” may include suitable methods and techniques for entering and/or being transported to a virtual location with our without intermediary transportation. Secret entry methods may be used in conjunction with surrogates, NPCs and/or identical twins, or other authorized entities and may involve entry start dates and times and/or may include required or optional passwords, secret codes or other methods of security, including, for example, use of encryption methods. In certain embodiments, such entry and/or transportation methods may be accomplished via any applicable means. Similarly, a “secret exit” may include suitable methods and techniques for exiting and/or being transported to a virtual location with or without intermediary transportation. Secret exit methods may be used in conjunction with surrogates, NPCs and/or identical twins, or other authorized entities and may involve exit start dates and times and/or may include required or optional passwords, secret codes or other methods of security, including, for example, use of encryption methods. In certain embodiments, such entry and/or transportation methods may be accomplished via any applicable means.

In the case that a player uses a private transportation option as described above, such Client may or may not choose to have a surrogate or “identical twin” continue to persist in the location from which he/she is transported. For the purpose of the present disclosure, a “surrogate” includes the class of avatars designed to resemble a player or player character and/or other parties, such as a Virtual Professional, and which are used as a placeholder or diversion while the player or player character or third party is engaged in other activities, including sensitive appointments with virtual professionals or other persons or players or player characters within the virtual or game environment. Surrogates may be operated or controlled by a separate player or player character or third party or software application, and may optionally include communications and/or warning systems connected to the surrogate owner in the event that a complex behavioral situation should arise. Similarly, an “identical twin” includes a class of avatars designed to resemble a player or player character or third party, such as a Virtual Professional, and which may be used as a placeholder or diversion while the player or player character is engaged in other activities, including sensitive appointments with virtual professionals within the virtual or game environment. Surrogates may be operated or controlled by a separate player or player character or third party or under or via computer program or application control, and may optionally include communications and/or warning systems connected to the surrogate owner in the event that a complex behavioral situation should arise.

If a surrogate or identical twin is used, other players or player characters or other entities need not necessarily be alerted to the Client's transportation. In such cases, a secondary screen or window may optionally appear, permitting the Client to both participate and/or communicate with the Virtual Professional while also monitoring and/or continuing to control the activities and actions of the “identical twin”. Alternatively, the twin can be an NPC and the NPC twin can be configured with a set of rules to behave as the player character until the player character has left the virtual appointment with the Virtual Professional. In the event that an NPC is faced with conditions for which it has no rules or is otherwise unwilling or unable to determine without further involvement, such NPC may send an Alert to the NPC's owner, so that such owner may provide instructions to the NPC and/or provide permissions, and/or take direct control of the situation. Such use of surrogate player or NPCs may apply generally in a virtual environment and does not necessarily apply only to Clients or Virtual Professionals, i.e., any player character or NPC or other virtual person may wish to make use of such surrogate players or NPCs for their own reasons.

According to some embodiments, a fee can be charged by the Virtual Professional or game environment provider or other entity to allow a player or player character to create a surrogate, or twin or NPC that can represent or be controlled by him when he is in a appointment or otherwise.

In addition or in the alternate, in certain embodiments, the actual or legal name of either the Client and/or the Virtual Professional may be desired, necessary or required before services can be rendered. For the purposes of the present disclosure, the term “legal name” includes the name and personal information of players and player characters or other entities and third parties, e.g., Virtual Professionals. Legal names may be verified, in whole or in part, by real or virtual-world documents, and may be required for certain levels of professional service, game stage or era access, special rates or offers, court appointments, professional certification, insurance and/or other goods, products or services and/or for other purposes.

Services may be rendered to a Client's avatar, or through any other applicable communications methods, including via chats, instant messages, alerts, videophones, audio, or telephone or cell phone, or web phone, e.g., IP phone, any of which may exist within the virtual environment.

Examples of when factual or legal names are desirable or required include, but are not limited to when: real Virtual Professional advice or services are to be rendered, such as any actual diagnosis or treatment, such as real psychotherapy, or when a real doctor wishes to prescribe real drugs to a real person, or when a real lawyer desires to provide real legal advice to a real person. For the purposes of the present disclosure, “treatment” may include any professional or non-professional service and/or use of any real or virtual: item, drug, remedy, potion, spell, herb, vitamin, preparation, or any other service, advice or application or use of any item that results in—or may result in a desired or other change, including, for example, an improvement in status, ability, skill, performance, durability, longevity, or otherwise, in one or more players or player characters or other third parties that receive such service, treatment, advice, or otherwise, including, for example—an improvement in the psychic or psychological condition or mental health or future prospects of such mental health of such player or player characters or other third parties and/or any combination of the forgoing. A “prescription” may include an instruction or document written or otherwise provided or authorized by, for example, a certified, virtual professional that authorizes the patient, e.g., a player or player character, to be provided with a real- or virtual-world medicine and/or treatment, including, for example, any real or virtual world advice, counseling, drugs, item, remedies, potions, spells, herbs, vitamins, preparations, or any other service, advice or application or use of any item, and/or any combination of any one or more of the foregoing.

Alternatively or additionally, real client names may also be required so that invoices may be generated using such real names and/or used to file or receive insurance claims and/or benefits. For the purposes of the present disclosure, the term “insurance” includes any real or virtual practice or arrangement by which a real- or virtual-world company, entity, person, player, player character, third party, or government agency provides a guarantee of compensation or other payment or form of compensation for specified or unpredictable events, which may or may not cause a loss of real or virtual assets, currency, items, property, etc., including, but not limited to: loss, damage, illness, and/or death, in return for payment of a premium and/or other form of compensation or renumeration.

According to some embodiments, when setting up an account, Clients and Virtual Professionals may be required to provide sufficient information to verify their true identity. For example, Clients and/or Virtual Professionals may be required to provide their social security numbers or other identification numbers, or professional identification, or other identification, e.g., if a from a country other than the United States of America, or other information, including, but not limited to, full name and address, real world driver's or other licenses, permits, Virtual Professional organization membership identification numbers, references, university or other higher education records, diplomas, certifications, certification numbers, permits, Virtual Professional organization membership names, ids, and dates, ongoing or continuing education agencies or institutions or credits, or other similar credentials and other means of identification. The system stores such information for analysis and may be used by the system, Clients or Virtual Professionals as permitted by the system. The system can validate and store this information so that Clients and Virtual Professionals do not have to validate this information before, during, or after a appointment.

In other embodiments, the system may combine the use of anonymous and actual names. For example, in an initial or introductory meeting either the Client or the Virtual Professional may wish to remain anonymous. Once the parties agree that services are required and/or will be provided, one or more of the actual names may then be divulged, generally or only to those interested parties, e.g., the Client and the Virtual Professional and, perhaps, any supporting staff members. Such use of a combination of anonymous and actual names may be determined or controlled by any applicable means and may be determined, in whole or in part upon any one or more of the following, including, but not limited to: the degree of sensitivity or nature of the reason or purpose or type of services to be rendered, or the notoriety of the person, e.g., a politician or other public figure, the insurance provider's preferences, law, regulation or rule, or any other factor affecting either the Client, Virtual Professional or any other affected parties, including, for example, the virtual game owner or other third party.

According to yet another embodiment, the present disclosure provides targeted advertising in and outside of the game. In this embodiment, real or Virtual Professionals can buy keyword advertising for in-game and outside-game searches. Keywords may include any one or more words, phrases, sounds, images or other identifier that may be used as a mechanism for attracting prospective clients and or other interested parties to any product and/or service. In certain embodiments, a keyword includes anything that may be used to conduct a query and/or to obtain information or useful or more useful results from such a query.

According to one method of keyword advertising, clicking on an ad may direct the potential Client to a log in or other screen of the game environment and/or initiate some other action or step. Once the potential Client has logged in (if required) and selected an avatar (if necessary), the avatar may be immediately inserted into the virtual office of the Virtual Professional or may be inserted at some other time, for example, just before or when an appointment is scheduled. Keyword ads may only appear when the Virtual Professional is logged in and not in session with another Client or is otherwise available to render services. In certain embodiments, the Virtual Professional may be paid in part or in whole by either the new Client and/or by the search engine. Search engines or other online services companies may charge a fee per service or use, and/or a subscription or annual or other periodic fee to have access to such services or simply to have the option to see results for such searches. Additional fees may be imposed by the Virtual Professional and/or the game owner, game server, franchisee, or any other interested parties.

In one embodiment, new and existing associations of real world Virtual Professionals may use the disclosed invention for the purpose of pre-qualifying, admitting, excluding or removing Virtual Professionals from their real world associations. For example, the New Mexico State Bar association may opt to use the disclosed invention to automate the process of signing up for the Bar exam and to keep track of lawyers licensed to practice in the State and their areas of practice, experience or expertise, whether or not in the real or virtual world.

Professional associations may also require real world or virtual professionals to perform a certain number of hours of service, to conduct a certain number of appointments and/or to achieve a certain level or rank of client feedback in the virtual world as a precondition of being granted a real world or virtual license or reinstating a suspended or revoked real world or virtual license.

In some embodiments, any player or entity can become a Virtual Professional. In other embodiments, and/or for certain highly specialized professions, e.g., psychiatrists, doctors, lawyers, engineers, only those individuals who hold the appropriate credentials and/or licenses in the real world are permitted to practice their profession in the virtual environment. These credentials may need to be registered and verified with the game environment provider before the Virtual Professional could practice in that environment.

In another embodiment, certain Virtual Professionals may only practice their profession or interact with Clients that are physically or virtually located in their licensed real and/or virtual geography. For example, by law, certain lawyers are permitted to practice only in certain jurisdictions or states. The term “jurisdiction” may the official or unofficial power to make legal decisions and/or judgments and/or to impose fines, penalties and/or confinement or any combination of these upon a player or player characters and/or other third parties. For example, in certain virtual or game environments, jurisdiction may be based upon factors such as virtual location, era, and activity type and/or real-world affiliation and/or via any applicable means. In such cases, attorneys whose practice is limited to one or more jurisdictions may be precluded from providing advice to a particular client due to the attorney or client's real or virtual location. For example, an attorney whose practice is limited to virtual New York may only be able to provide advice regarding virtual New York law. Furthermore, the attorney may only be able to provide advice to clients who are residents of virtual New York or who are physically present in virtual New York.

In yet another embodiment, Virtual Professionals may be permitted to practice their profession in any real or virtual location, while operating within the virtual environment.

In certain cases, Clients may opt to receive limited or onetime services from a player Virtual Professional. In such cases, it may be desirable or required that the client pay for services before, during or after services are rendered. In other cases, Clients, especially those that require ongoing services, as might be the case when seeking psychiatric services, may choose to pay for services over time using any one or more financial instruments, including debt instruments, e.g., credit cards. Credit services may be offered by the Virtual Professional or via a third party financing or lending institution, such as those offered by Visa or MasterCard. Financing alternatives may be offered within the game environment or in the real world or a combination of these. Methods to provide such financing options are disclosed by applicants in U.S. patent application Ser. Nos. 11/380,489, 11/421,025, 11/559,158, 11/620,542, 11/693,576, 11/535,572, and 11/535,585, each of which are hereby incorporated by reference.

According to yet another embodiment, players may also acquire “Virtual Professional Prepaid Codes” that can be purchased in the real world or online and used to purchase the expertise of a Virtual Professional. For the purposes of the present disclosure, a prepaid code may include any key, password or encrypted string or object that can be purchased in the real- or virtual-world for the purpose of obtaining the services of or access to a Virtual Professional, and/or other products and/or services including obtaining treatment. These codes can be used to purchase any Virtual Professional service, or can be limited to Virtual Professional services of a particular Virtual Professional or class of Virtual Professionals.

According to yet another embodiment, the present disclosure provides Virtual Service Coupons. For the purpose of the present disclosure, “coupon” includes any electronic and/or printed document or voucher and/or code that entitles the holder or recipient to a discount or other financial incentive or reward for purchasing, acquiring or otherwise making use or benefiting from a particular product and/or service, including purchase of any real or virtual product, good or service, including any treatment. Coupons may be offered in the real- or virtual-world and may or may not include expiration dates, requirements and/or restrictions on their usage, e.g., requiring the holder or recipient to identify themselves and/or make use of such coupon only during certain hours of the day or with only certain businesses or players or player characters, including, e.g., virtual professionals.

According to an exemplary embodiment, a Virtual Professional can purchase or otherwise make available service coupon codes and email or otherwise distribute them to Clients or players in the game to promote a free or discounted session of his service. The game environment provider can manage the distribution of such coupon codes for a per code fee. The game environment provider can also target the distribution of such coupons to players who behave in a certain manner in the game environment and are likely to accept the offer. Players can also register what types of service offers they would like to receive and the game environment sends Virtual Professional coupons to those players based on the specified preferences. In another embodiment, Clients or prospective Clients may opt to perform services, e.g. training newer players, in exchange for receiving a coupon or discounted Virtual Professional services.

According to various embodiments, player characters or current or prospective Clients wishing to visit a Virtual Professional can request such a visit or services by any applicable means, for example, a Client could log in to a “Virtual Professional services finder” or search tool and enter one or more preferences or types of services sought for a given field or profession. The system could then compare all the available Virtual Professionals and their respective credentials and specialties and matches the most likely Virtual Professional based on the player character preferences and/or services sought. Player preferences may include any set of options, descriptions and/or specifications that are directly or indirectly associated with a player or player character profile and/or their game play or any other information. In certain embodiments, player preferences may be used to determine appropriate professional services, e.g., treatments, or for advertising and/or other profiling purposes and/or may be used to affect how a virtual environment reacts to such player or player characters or vice versa and/or any combination of the forgoing. The player character can then view a list of available Virtual Professionals and select from the available list. According to some embodiments, professionals can pay to be listed or ranked in such a listing and their listings only show when a player requests a certain service and the Virtual Professional has open time to service the player.

In one embodiment, Virtual Professionals may opt to provide an initial or subsequent consultation with no charge or for a lower than usual fee. In such cases, Virtual Professionals may establish a limit on the amount of time provided at such reduced rates. Professionals may provide an indication as to the type of player that is eligible for such services. For example, certain Virtual Professionals may only offer reduced rate or free services to those that fit certain profiles or have certain financial resources, assets, attributes, or fit specific profiles or who demonstrate certain levels of need.

In another embodiment, certain Virtual Professionals may be willing to accept reciprocal services or other items in exchange for services. For example, a Virtual Professional psychiatrist may offer 10 hours of services in exchange for 100 barrels of virtual oil. Such bartering may include exchanges of real and/or virtual goods and services, and/or any combination of goods and services and real or virtual currency and/or use of any other financial instrument, such as a promissory note or real or virtual credit card. Items can be placed in escrow or secured with a real world financial instrument and released to the Virtual Professional when the services have been completely provided.

According to yet another embodiment, the system may be configured to determine appropriate Virtual Professionals based on comparing the player character or Client profile and play history to other player characters profiles and histories who have gone to a given Virtual Professional and rated their experience with that Virtual Professional. Player history may include, for example, the textual, audio and/or visual records or other information of a player's past or current behaviors and/or activities and/or preferences and/or treatments provided and/or the results or feedback relating to or derived from such treatments or otherwise. Player histories may be encrypted and may be accessed only under certain conditions by certain entities or individuals or by authorized personnel and/or applications. In addition to finding appropriate Virtual Professionals using this method, the system can also provide a marketing offer to visit a given Virtual Professional to a player character or Client based on his play history and how it relates to the play histories of other player character's or Client's play history and their ranking of Virtual Professionals they have used.

According to yet another embodiment, player characters or Clients who break one or more of the rules of the game may have some virtual rights removed until they visit a virtual psychiatrist for a fixed number of times or hours, or until the virtual psychiatrist indicates that they are ready to have their virtual rights reinstated.

In another embodiment, players who behave in a certain way or who engage in certain interactions may automatically receive in-game interstitial, popup, up-sells or other offer or invitation for services provided by certain classes or types of Virtual Professionals. For instance, a player character or prospective Client who spends most of his time in virtual world casinos can be offered the services of one or more gambling addiction consultants.

According to yet another embodiment, Clients visiting a Virtual Professional can create the look of the Virtual Professional during the appointment. In another embodiment, the Virtual Professional controls all or part of his character's (e.g., avatar's) appearance.

In certain cases, the Virtual Professional can prescribe medication based on a medical profile of the player. Such prescriptions may be for real or virtual medicines. In the case of real medications, prescriptions can be written and emailed or fulfilled securely and mailed to the player. Payment for such medications may be made by any applicable means, including those disclosed herein, such as with a virtual credit card. Players may be required to submit real world medical records, blood types, and DNA types in order to be eligible to receive prescribed medication from a Virtual Professional.

In some embodiments, clients may be required to visit a physical office to complete interviews, meetings, physical exams or for any other purpose. In such cases, appointments can be made using an online scheduling program and/or with a virtual world program or manual method. In certain embodiments an application program interface is provided that permits real world scheduling programs, such as Microsoft's Outlook program and may be used within used within the virtual world. In yet another embodiment, Outlook may be used as both the real world and the virtual world calendar/appointment application.

Any form of virtual dispute resolution may be managed by the system. Methods to resolve disputes in a virtual environment are disclosed in U.S. patent application Ser. No. 11/755,539 which is incorporated herein by reference.

In certain embodiments, Clients and Virtual Professionals may choose to combine real world interactions with virtual world interactions. For example, a prospective Client and Virtual Professional may meet for the first time in the virtual world and then schedule one or more appointments or meetings in either the real world or in combination with virtual world appointments, e.g., alternating between the real world and the virtual world. Virtual Professionals may charge different fees for real world vs. virtual world appointments/meetings. For example, virtual world appointments may carry a lower fee than the real world or vice versa.

In certain embodiments, services may be delivered other than in real time. For example, a Client may submit legal or medical questions to a lawyer or doctor (respectively) and responses may be made immediately (i.e. in real time), or they may be provided at another time. Such methods permit the Client to submit questions or issues at a time that is convenient to the client and allows Virtual Professional to respond when it is convenient for the virtual professional. Clients willing to accept delayed responses may be charged a different fee from those that require or demand immediate responses. Such fees may be higher or lower than the fees for immediate response.

In addition or in the alternate, Clients may submit questions to a specific Virtual Professional, or to a pool of Virtual Professionals. The Client may further indicate the type of service(s) required and other desired attributes or qualifications, which could narrow the pool of potential Virtual Professionals that could respond to any such submitted Client question(s). Virtual Professionals may then retrieve the Client's submitted questions in any order or by any means applicable. Suitable means include, but are not limited to, in the order submitted, or based upon a fee paid by the Client, or a bid or auction of a position (or other methods or priority queuing as disclosed herein by applicants) or based upon one or more controlling criteria, e.g., cost of the Virtual Professional or their hourly rate, the current workload of one or more acceptable Virtual Professionals, the amount of revenue a Virtual Professional is willing to share with the virtual environment, virtual game, game owner, server owner, and/or franchisee or any other affected third parties, and/or one or more real world entities, e.g., the real world business or other entity the Virtual Professional works for generally or periodically, e.g., a law firm or hospital, and/or the retrieval of the Client's submitted questions or requests for services may be determined by a willingness of the Virtual Professional to pay for services requests. Payment amounts may be determined by any applicable means, including, but not limited to: a lottery, a market, exchange or auction, and/or other methods of priority queuing as disclosed by applicants herein, and/or any combination of the forgoing.

In certain embodiments, players, player characters, Clients and/or Virtual Professionals may be notified of requests for Virtual Professional services or provide responses to such requests or otherwise send or receive communications via a messaging system or alerts. In certain embodiments where alerts are provided, Clients and/or Virtual Professionals may pay a fee to be notified ahead of other Clients/Virtual Professionals, as applicable. Such fees may be static or dynamic or subject to market forces. Furthermore, Clients and/or Virtual Professionals may opt to increase their priority using priority queuing methods as disclosed by applicants herein.

In addition to those Events disclosed in the forgoing application, a player may be notified
a. When a Virtual Professional is logged in
b. When a Virtual Professional has an open time slot
c. When a Client is logged in
d. When a Client has purchased a twin or single use avatar
e. When a Client is available for or has requested services to be rendered
f. When a Client has paid or has failed to pay an amount when due

In another embodiment, any player or player character may become or apply to become a Virtual Professional. When Clients seek a Virtual Professional, information regarding the Virtual Professional's credentials are presented to the prospective Client. In this scenario, for example, prospective Clients may choose to speak with a virtual psychiatrist that is a real psychiatrist in the real world, or, they may choose to speak with an individual, i.e., player or player character, that is providing services without any formal education, certifications or licenses. In such cases, the system may display the fact that any given Virtual Professional is or is not licensed, be it in the real and/or virtual world. In this way, certain players or player characters may provide certain services, e.g., assist a virtual character, with virtual “problems” without necessarily having any real expertise, other than, perhaps, a track record or reputation for being helpful within the virtual world.

In another embodiment, Virtual Professionals, whether or not licensed or certified in the real or virtual world, may have rankings and/or comments or reviews displayed as or relating to their proficiency, service levels or reputation. Such rankings or “reputation scores” may be entered by Clients and/or may be imported from other games or from real world services that contain, maintain or otherwise provide such rankings or scores. By permitting those individuals, real or virtual, to provide feedback and satisfaction or other reputation scores or satisfaction ratings or commentary (which commentary may be text, audio and/or video), the system can provide useful information to those players or player characters, Clients or other third parties with potentially valuable information regarding the perceived quality or value of any given Virtual Professionals. Any player, player character, Client or any other third party that has used a given Virtual Professional's services may enter or record such rankings, scores and/or commentary. Rankings may only be numerical, e.g., a rating of one to ten, with ten being the highest and/or the Client may be permitted to enter free form text or record an audio or video opinion. Additional opinions (either text or audio and/or video) may be limited as to the amount of space or time and/or may not have any limit.

In another embodiment, when recording opinions for a given Virtual Professional, there may be a fee to record such opinions and/or rankings. Or, a basic raking and opinion may be recorded for free, but a more detailed, e.g., lengthy opinion, may require the Client to pay a fee. Such fees may be fixed, variable or based upon the length of the entry, e.g., textual, audio, video, etc.

In another embodiment, when a fee is required, the Virtual Professional may opt to waive or pay for part or all of such fees in order to receive more detailed feedback from the Client. In addition or in the alternate, Virtual Professionals may be required to pay for all or part of any such fees if such opinions are favorable or unfavorable, or based upon any other discriminating or applicable criteria.

In yet another embodiment, the Client, Virtual Professional and/or the virtual game may use the system to keep records of all Client/Virtual Professional interactions. Such records may be minimal, e.g., a record of the names, times, dates and duration of each interaction, or detailed, e.g., a comprehensive record of all interactions, including, but not limited to the forgoing information, plus any one or more of: the actual text, audio and/or video of the transaction from either the Client's and/or the Virtual Professionals point of view, or partial or complete recordings of the video game environment's application processing, including the ability to recreate the entire transaction on a display, which may include the option of using a split screen, so that the player, player character, Client, Virtual Professional or any authorized third party can view the entire interactions between the Client and the Virtual Professional as if it were occurring in real time. Such features may prove useful to the Client or the Virtual Professional to review each interaction and/or the Client, Virtual Professional or an interested third party, e.g., a virtual judge or jury, might review such materials in the event that a dispute arises out of or relating to any one or more such interactions. Such records may also be used to keep track of or generate or deliver bills, invoices, statements and other financial records to one or more Clients, which may be reviewable and/or modifiable by the Virtual Professional or his designee, e.g., a real or virtual: clerk, nurse, insurance agent, financial institution, etc.

In certain embodiments of the present invention, a Virtual Professional may not be able to practice, or such practice may be limited until the Virtual Professional is licensed to practice, or until certain levels or eras of game play, or until one or more requisite skills or experience are obtained, or the Virtual Professional has achieved a certain level, or within certain eras, or until the Virtual Professional is licensed and/or pays for such a license and/or has signed up for and/or paid for a special player account or account classification, or has attended and/or passed certain required training courses.

According to another embodiment, Virtual Professionals may be required to purchase a permit to practice in the game environment. Such permits may be for a limited or unlimited time or may be restricted to certain eras or areas within the virtual environment or game. Fees for permits may be determined by any applicable means, including, but not limited to, one or more or any combination of: based upon the type of services to be rendered, the amount of time required or number of anticipated or actual number of appointments or elapsed time or total hours, the type of account held by the Client or the Virtual Professional, the expected benefit of such services, the risk associated with providing such services, the amount and type or provider of insurance carried by the Client or the Virtual Professional or both, market forces, e.g., supply and demand, or via an exchange or auction, or randomly. In certain embodiments, such permits may be valid for multiple video games or virtual environments.

According to another embodiment, Virtual Professionals can have offices in several game environments at once. In such cases, the system may provide for scheduling conflicts between or among the various office and/or game environments. Furthermore, Virtual Professional availability may be determined, in whole or in part, based upon the current or expected fees that may be different between such offices or game environments. For example, if Game A general pays $250 per hour for legal services, while Game B generally pays $750 per hour for legal services, then, the system might: a) strive to use all available hours of the Virtual Professional, e.g., lawyer, in Game B before making any hours available to Game A, or b) mix the number of hours between Game A and Game B, where, for example, the system allocates 25% of the Virtual Professional's hours to Game A and the remaining 75% to Game B, or c) any combination of the forgoing or any other applicable means.

In certain embodiments, Virtual Professionals may maintain a calendar which indicates their hours of availability and/or their preferred hours and/or services, rates, Client profile, experience, availability of supporting personnel, etc.

Virtual Professionals may have to pay a monthly or per appointment or other fee, e.g., share a percentage of the Client or other entity, e.g., insurance company, to the virtual government and or game environment and/or franchisee owner, where their office or link to their office is located (whether or not a real and/or virtual office), and/or where services are rendered. In addition or in the alternate, Virtual Professionals may have to pay a real world organization to register or to be licensed to practice in one or more virtual environments. For example, the Virtual Professional may have to pay a fee to the Bar Association or to a hospital or a law firm, or a government regulatory body, or some other real world entity. Such fees may be fixed or variable and may or may not be based upon any of the criteria disclosed herein. For example, such fees may be based upon the actual fees received by the Virtual Professional from Clients. Fees may be required in advance, during or after providing services to Clients. For the purposes of the present disclosure, a governing body may include one or more or a group of people and/or players and/or player characters and/or other duly authorized entities or third parties, or any combination of these, who are elected, appointed, anointed, or are otherwise empowered or have the duty to formulate one or more policies, administer systems or agencies and/or direct the affairs of an institution and/or are authorized or otherwise have the power or duty to make decisions that may affect other players or player characters or other third parties, e.g., virtual professionals, or NPCs, etc., which may or may not be in partnership with real or virtual authorities, courts and other legal and regulatory entities and/or any combination of the foregoing and/or possess the power to grant others the right or duty to conduct any one or more or any combination of the foregoing.

In other embodiments, players or player characters or Clients may not be permitted to receive some or all services from some or all Virtual Professionals until they have achieved a certain level, paid a fee for such services, in whole or in part, or provided a valid real or virtual credit card or other financial instrument to pay for such services, or signed or otherwise executes an enforceable player to player contract. Methods that permit the creation and enforcement of such contracts entitled are disclosed in U.S. patent application Ser. Nos. 11/11/279,991, 11/611,050, 11/355,232, and 11/624,662, each of which is hereby incorporated by reference.

In yet another embodiment, in the event that a dispute shall arise between a Client and a Virtual Professional, such dispute may be resolved through any legal means applicable, including, but not limited to an automated online process where the Client and the Virtual Professional state their case to a judge and/or jury. Methods that permit such mediation and resolution of disputes are disclosed in U.S. patent application Ser. No. ______ (Attorney docket no. 3110101) which is hereby incorporated by this reference.

In another embodiment, a Client may reside or play or otherwise interact within one game environment, while the Virtual Professional may reside or play or otherwise interact within another game environment, and, by using an application such as an application's program interface (or API) or some other means of communicating between two distinct game environments, a Client and Virtual Professional may interact as if they are both within the same video game environment.

In certain embodiments, players or player characters may be required to pay taxes or other fees that are distributed to Virtual Professionals that are supported by a group, class or all of the players or player characters within a game environment. Such a system would provide Virtual Professionals without charge to those players or player characters, or Clients in need of such services. In this fashion the cost of such services would be spread over a larger number of players or player characters while encouraging accessibility and availability of one or more Virtual Professionals. In such cases, the allocation of fees to one or more Virtual Professionals may be determined by any applicable means, including any one or more of, but not limited to: based upon the total number of hours of service provided, the skill level of the Virtual Professional, the type of services rendered, e.g., doctors may receive higher fees than hypnotists, the type of case, the type of player, or player character, or type of Client or the skill level, ranking or other attributes or characteristics of either the Client and/or the Virtual Professional, including the type of account of the Client or Virtual Professional, the history of services received or rendered by the Client/Virtual Professional, etc. Methods that provide for the assignment and collection of taxes and other fees are disclosed in U.S. patent application Ser. No. 11/696,080, which is hereby incorporated by reference.

In yet another embodiment, certain laws or regulations may be passed to control the services rendered to Clients and/or to determine which players or player characters or third parties are to be licensed to provide services. Such laws or regulations may be any rule, law or regulation as deemed desirable or necessary. Such laws may be determined by any authorized person or persons, including, but not limited to the game owner, developer, server host owner, or group of players, player characters, and/or group or subgroup of Virtual Professionals or any other third parties, and/or any combination of the forgoing. Examples of laws might include: before practicing within a virtual environment, or with a certain class of Clients, a Virtual Professional may be required to obtain a license, or, to obtain a license, a Virtual Professional must first present real world credentials and/or licenses either in person and/or via electronic means to the duly authorized individual or individuals and/or maintain such records current within the game environment or in another designated location, or, before receiving any services within the game environment, a Client must remain current with any payment obligations, such as amounts owing to the game owner or service provider, or to the Virtual Professional, or such Client(s) must be current with some or all debt or payment obligations with some or all other players, player characters, real or virtual financial institutions or any other third party and/or other related or unrelated Virtual Professionals.

In certain embodiments, if a Client is found to have any real or virtual type of defect, deformity, ailment or other malady or is found to possess or lack certain skills or abilities and/or attributes, the system or the Virtual Professional may modify one or more attributes of the Client and/or take other actions, whether or not such actions are authorized. For example, if a Client is found to be insane, the Virtual Professional may alter the Client's avatar, such as placing the avatar in a virtual straightjacket. Such modifications or changes may or may not affect the Client's ability to play the game or make use of objects within the game. For example, a straightjacket may restrict the Client's ability to use his hands, arms or legs within the game. Examples of event-driven avatar alteration are described in U.S. patent application Ser. Nos. 11/694,648, 11,693,549, and 11/693,543, each of which is hereby incorporated by reference.

In some embodiments, security may be a critical concern for either or both of the Client and/or the Virtual Professional. Any system that offers access to Clients and/or Virtual Professionals may include an option or a requirement to encrypt some or all of the various data associated with or generated by such access and/or any and all interactions with said Clients/Virtual Professionals. Encryption may include the process and/or methods of converting information or data into a cipher or code, especially to prevent unauthorized access and/or to obscure information so as to make such information unreadable or unusable by any unauthorized system or party. In certain embodiments, for example, in the context of virtual professionals, encryption may be used to protect sensitive client records and information, including dates of any appointments, discussions and/or treatments or other services provided and/or the results of such treatments or services. Methods to encrypt and store information, data, audio, video and other computer media are well known within the prior art and anyone with ordinary skill in the art would understand that there are various means that are readily available to provide for any such encryption. These methods can ensure that only those that are authorized to access such information are permitted to do so.

In the event information is encrypted, there may be a method for a third party to access the codes required to decrypt such information. For example, in the event of a dispute between a Client and a Virtual Professional or a virtual lending institution or credit card company, one or the other of the forgoing may request access to previously encrypted records for use in a real or virtual legal proceeding. In such cases, the system may restrict access to only those that were a party to the transaction, and/or a judge or jury or other authorized person or entity. Such access may be provided by giving access to the cipher or encryption code and/or by simply permitting limited access or viewing time to such authorized parties, including, but not limited to: judges, juries, Clients, Virtual Professionals, third persons, etc. Methods to encrypt data and other digital materials are well known in the prior art and anyone with ordinary skill would be capable of implementing such an encryption system.

In certain embodiments of the present invention, approval, certification or registration of Virtual Professionals may be partially or completely dependant upon non-automated review methods, for example, a prospective virtual doctor may be required to apply to a panel of previously certified or licensed virtual or real doctors or other players. Such application may be submitted by any applicable means, including, email, telephone, in person, via chat session or by attending a review meeting in person or within the virtual environment. There may be two or more such panels which may be authorized to certify any prospective Virtual Professional or they may be broken into groups or subgroups, for example, there may be a single certification panel that approves or rejects all prospective virtual doctors, or there may be subgroups, or specialty groups, such as a group for endocrinologists and another for cardiologists, etc. The determination of the number and type of such groups may be made by any applicable means and includes, but is not limited to any one or more of: replicating the structure and process of similar governing bodies in the real world and/or by the game owner, a duly authorized elected body, by those previously approved, by any existing or new real or virtual rule, regulation or law, by two or more players or player characters, or by any other useful means or any combination of the forgoing. If meetings between prospective Virtual Professionals and existing Virtual Professionals and/or real professionals, such meetings may take place in the real world, and/or such meetings may take place within the virtual environment.

According to some embodiments, Virtual Professionals may lose their license if Clients vote to kick them out of the system. A certain percentage and/or number of votes may be required to either revoke the license of the Virtual Professional or force the Virtual Professional to be reviewed by a panel of peers or experts or other Virtual Professionals. Such revocation may be temporary or permanent and/or may restrict the Virtual Professional from providing some or all of his services.

In another embodiment, Virtual Professionals may choose to allocate some or all of their time providing Virtual Professional services in exchange for services from Clients, and/or for free play time or other in game or real world benefits. Such benefits include the acquisition of player attributes or objects, free or reduced fee play time, free or reduced costs on virtual property, including virtual real estate, player attributes, such as the ability to sell a potion or spell, or the ability to use armor, or other similar skills or attributes. Such benefits may be delivered before, during or after such services are provided. Virtual Professionals may elect which benefits they would prefer, e.g., instead of in game benefits, Virtual Professionals may choose to have points added to their real world credit card. Methods that permit the allocation of points or providing free play for services in a virtual environment are disclosed in U.S. patent application Ser. No. 11/676,848, which is hereby incorporated by reference.

In certain embodiments, Clients may be directed to virtual waiting rooms to await services from Virtual Professionals. Such rooms may be virtual representations of waiting rooms, or such queues may be merely one or more waiting lists where one or more Clients await services. In some embodiments, there may only be one waiting room or there may be multiple waiting rooms. In cases where there is more than one waiting room, such waiting rooms may be organized or grouped using any applicable means, including, but not limited to, for example, certain room(s) may be designated by type of or dedicated to one or more Virtual Professionals and/or by type of service. For example, one waiting room may be designated for those Clients awaiting legal services, while another waiting room may be designated for those Clients awaiting psychiatric services. In another example, a specific waiting room may be created for Doctor A, while another waiting room, perhaps in another real or virtual location may be “occupied” or otherwise used or assigned to Doctor's B, C, and D. The number and size of each room may be fixed or variable. Rooms may be plain or empty, or may be decorated, perhaps elaborately or befitting the services to be rendered. Variable sized waiting rooms may be adjusted, as to the size of available queue positions, based upon number of Clients awaiting services, type of services, and/or number of physicians and/or their known or projected rate of providing services, or via any other applicable means. The look and feel of waiting rooms can be customized by any one or more of the Client, Virtual Professional, game owner, services providers, server owner or any other authorized third party or any combination of the forgoing. Waiting queues can be placed in the virtual world GUI so that the waiting Client can continue virtual world activity until he reaches the top of the queue. Accordingly, an “appointment queue” includes a list of appointments that are agreed upon and/or ordered by any factor, including but not limited to: date and time scheduled, client precedence, payment rates, bid price, appointment urgency, and/or other factors. Appointment queues may be managed automatically by the system and/or manually by the player or professional providing the appointments and/or by any system or third person authorized to manage such appointment queue(s).

While awaiting services or an initial consultation, whether or not such waiting takes place in a waiting room or not, and/or anytime before, during or after services are rendered, Clients may be asked one or more questions regarding their needs and preferences. This information may be useful to the Virtual Professional in determining the Client's needs or diagnosis, or recommending action, services, etc. Such questions may be stored in a database for such purposes. The creation and maintenance of such a database may be provided by the game itself, and/or by one or more Virtual Professionals. In some cases, the questions may be standard questions provided by a group of Virtual Professionals. In other cases, the questions may be entered, in whole or in part, by the Virtual Professional. Such questions may be specific or generic, and/or they may be probative or diagnostic or simply gather basic information from the Client. In such cases, the information may be stored and may be encrypted and/or may be accessible by the Virtual Professional only, and/or the Client and/or other authorized Virtual Professionals and/or other authorized third parties. Such information may reside within the game environment, and/or within a central or other server provided for that purpose, which may be hosted by a service provider or franchisee that resides outside but is otherwise in communications with the video game server. There may or may not be a fee charged to or by any one or more of the Client, Virtual Professional, video game server, and/or franchisee or any combination of the forgoing for the entry and/or storage and/or access and/or use of such information. Accordingly, a virtual file may include the personal or other information, notes, records, and any other textual, audio and/or visual logs that are associated with a given client. Virtual records may be identified with independent players, player characters, temporary aliases and single-use avatars, or may be associated with the real-world legal custodian, according to the dictates of any legal, medical, insurance and/or regulatory requirements. Virtual files may be encrypted and may be accessed only under certain conditions by certain authorized entities or individuals.

Furthermore, the Client may also have access to additional information and/or terms and conditions relating to or controlling the access or receipt of services and/or the Virtual Professional. For example, while waiting service, and prior to any services being rendered, a Client may be required to read and sign one or more contracts, such as a Player-to-Player contract, and/or execute any one or more waivers or authorizations for services to be rendered, which may include disclosures of fact, risk factors, potential benefits or harmful side effects, etc. In various embodiments, a contract may include any written, spoken or otherwise recorded agreement that is intended to be or is enforceable by any real or virtual law. In relation to the services offered by virtual professionals, contracts may relate to the terms, conditions and/or costs of those services. In certain embodiments a contract may be any instrument that is legally binding or may be enforceable based upon the exchange of promises of, by or between any two or more real or virtual players, player characters, NPC's, virtual professionals, avatars, business entities, and/or any combination of the foregoing.

If such waivers, contracts or other documents are requested or required, the information may be stored and may be encrypted and/or may be accessible by the Virtual Professional only, and/or the Client and/or other authorized Virtual Professionals and/or other authorized third parties. Such information may reside within the game environment, and/or within a central or other server provided for that purpose, which may be hosted by a service provider or franchisee that resides outside but is otherwise in communications with the video game server. There may or may not be a fee charged to or by any one or more of the Client, Virtual Professional, video game server, and/or franchisee or any combination of the forgoing for the entry and/or storage and/or access and/or use of such contracts, waivers, forms and the like.

According to some embodiments, while receiving services from a Virtual Professional, the Client may opt to employ an NPC or surrogate to continue some or limited game play during each such appointment or while services are being rendered.

In some embodiments, Clients waiting in a waiting room (or in a queue awaiting services) may opt to request an improved position within the room or queue. Certain Clients may be in immediate need of certain services and/or they may simply be willing to pay to move up within a queue. Clients awaiting services may opt to pay for a higher priority within a queue. Many variations on options to permit or otherwise improve or change positions within a queue are disclosed in U.S. patent application Ser. Nos. 11/11/462,621 and 11/611,024, which are hereby incorporated by reference.

In the event that a Client pays for higher priority, such fees may be distributed to any one or more of the following, including the Virtual Professional, the video game, video game environment, franchisee, game server, hosting company or any other interest/affect third party depending upon the terms and conditions then in effect or otherwise negotiated among the parties. Fees may be determined and/or allocated/distributed by any applicable means. Fees may be random, fixed, variable, or subject to an auction or other bidding system or as defined by any of the controlling or interested/affected parties or via any other means as disclosed herein.

In certain embodiments that may not provide for priority queuing, Clients may be provided services in the order in which they enter the queue, that is, first come first serve, or they may be provided services according to need, insurance program, historical payment records, ability to pay, severity of need, or any other applicable means. Clients may be required to pay for part or all requested/needed services before being admitted to a queue and/or before receiving services. Queues can be for a particular Professional or a particular class of Virtual Professionals.

In some embodiments, Clients that are awaiting services in a queue, may do so without their avatar residing within the queue, but may request a notification when an appropriate Virtual Professional becomes or is soon to become available. Clients may be notified that they are next in line, or periodically notified as to their current position and/or expected time to receive services. Notification of queue positions to Clients may be accomplished via any applicable means including automated alerts. Methods for sending such alerts are disclosed in U.S. patent application Ser. No. 11/676,848, which is incorporated by reference.

In another embodiment, a Client may choose to hire or assign an NPC to wait in line. As the NPC nears the front of the line or queue, the NPC or system can send a notice to the Client with sufficient lead time to permit the Client to return to the waiting room. The system may notify the Client once or more than once. The time and frequency to notify the Client may be determined by any applicable means, including, at predefined intervals or frequencies, as set by the Client or Virtual Professional, and/or by automatically estimating the time remaining before the scheduled appointment by using past services experiences, e.g., by using the number of Clients in line, the type of services required or expected and the expected amount of time required to deliver the same or similar services with the same or similar Clients. When the appointment is nearing, the NPC or system may send an alert to the Client to notify them to return to the waiting room and/or the system may automatically transport or return the Client to the waiting room without any further action or approval of the Client.

In some embodiments, services provided by Virtual Professionals may be hosted on servers, including central servers and/or independent virtual games or third party virtual environments, other than the virtual environment or video game in which the Client seeking services. In such cases, services may be provided for a fee by the owners or providers of such services, virtual games and/or third party virtual environments. Communications may be facilitated between and among such systems to provide communications between servers, virtual environments, independent games and otherwise so that Clients and Virtual Professionals can effectively communicate and/or exchange billing and other information. Such communications and billing systems may also be utilized by providers of such systems, servers, virtual environments, independent virtual games and/or any other applicable third parties.

In certain embodiments, the system matches Clients to Virtual Professionals using attributes and/or preferences or other criteria provided by the Client and/or the Virtual Professional. For example, a Client seeking a virtual lawyer might indicate that he is seeking an attorney that practices patent law, with a specialization in the field of video games or virtual commerce. Meanwhile, a virtual lawyer might indicate that she is seeking Clients that are willing to trade certain game attributes for Virtual Professional legal services that includes patent law and video game commerce. When the system finds a full or partial match of Client and/or Virtual Professional requirements and/or preferences, the system displays such “matches” to each of the potential Clients and Virtual Professionals. Lists of Clients and/or Virtual Professionals may be sorted in any applicable order including, for example, based upon percentage match, alphabetical, price, type of service required, dates of service, skills, certifications, payment method preferences, financial resources, availability of attributes, licenses, education, experience, references, and/or any combination of the forgoing. In certain embodiments, the Client and/or the Virtual Professional may choose to provide additional criteria such as a weighting ranking of any one or more of such criteria. For example, a prospective Client might indicate that the number of years of experience of a Virtual Professional is generally more important than the school that the Virtual Professional attended. Weighting factors may be indicated numerically, e.g., ranking each preference from 1 to 10 with 10 being highest, or by providing relative rankings, e.g., High, medium or low. Finally, Clients and/or Virtual Professionals may choose to include availability or location preferences as to time of delivery, duration, and other time criteria. Using this information can help ensure that services are rendered when and where desired. By combining such preferences and attributes with such ranking or weighting criteria, the disclosed invention can provide optimal matching of Clients to Virtual Professionals and vice versa.

In some embodiments, when prospective Clients are matched to available Virtual Professionals, the system may be configured to automatically establish an appointment or initial meeting between the two, the time, date and location for such meeting may be established, in whole or in part on previously submitted attributes and preferences, in addition or in the alternate, the system may provide notice to the Client and/or the Virtual Professional. Such notice may be provided via an alert or any other applicable means.

According to yet another embodiment, the present disclosure provides for Virtual Meetings wherein players can purchase a virtual space during a specified time period to conduct a meeting. The game environment may be configured to encrypt and record the meeting and allow the meeting file to be reviewed by participants and other players specified or authorized. The game environment can charge a fee for any one or more of: providing the meeting space, recording the meeting, and making the copies of the meeting available to approved players. A code can be emailed to potential players that allows them to log into the meeting space at the specified time. In addition or in the alternate, the system may send alerts to remind players when and where to log in for such meetings. For example, an alert might be sent one day before the meeting and then again five minutes before the start of a meeting.

According to yet another embodiment, real world cameras can be inserted into the virtual meeting space so that meeting participants can actually see each other in the virtual space.

In yet another embodiment, appointments may be entered into a database to permit the Client and/or the Virtual Professional to remain current and advised as to each appointment and location. Such a system may be further expanded to include useful information about Clients, such as Client case history, or any other useful or applicable information. For example, if a Client is the patient of a virtual doctor, a system might include, but is not limited to, information about the Client, i.e., patient's, medical history, symptoms, currently prescribed medicines, vital signs, trends, family history, diagnoses, prognoses, planed or recommended procedures, advice provided, therapy required or planned or any other useful and applicable data.

Appointment calendars and/or records for Clients and/or Virtual Professionals may optionally be encrypted such that access is limited to only those that are authorized to access such information. In certain embodiments, encryption codes or ciphers may be accessed when or if necessary by any judge, jury or other duly authorized authority if such access is necessary or warranted due to a dispute that may arise between the Client and the Virtual Professional.

Access to such codes or ciphers may also be granted in the event that a Client chooses to transfer his case to another Virtual Professional. In cases of transfer, e.g., a Client chooses a new Virtual Professional or a Virtual Professional transfers a Client, the system may transfer all or part of the records to the new Virtual Professional. During such transfer, the system may either provide the codes or ciphers to decrypt the encrypted data, or the system may replace and re-encrypt such data using the new Virtual Professional's codes or ciphers. Access or replacement of codes and/or ciphers may be necessary to provide the new Virtual Professional with access to a new Client's records. Professionals and Clients who have set up appointments can be notified of those appointments outside of the game environment using the “alerts system”

In certain embodiments, Virtual Professionals, Clients and/or other players, player characters or third parties may provide a reference or a referral, either to a Client or a Virtual Professional or any other party, which may included paid references and/or referrals. For the purposes of the present disclosure, a “reference” may include any player or player character who recommends one or more players or player characters to a Virtual Professional for the purpose of obtaining professional services or treatment. In certain embodiments, references may operate in either the real- or virtual-world, and may or may not be paid for such referrals. Similarly, a “referral” may include the directing of a client to a real or virtual medical and/or other specialist by a Virtual Professional. In certain embodiments, referrals may be required in the virtual world by real- or virtual-world insurance policies, and/or by certification agencies and/or regulatory and/or legal entities.

In some embodiments, those individual(s) that refer a client to a Virtual Professional or a Virtual Professional to a Client, or any person that provides a reference or referral may be compensated for providing such reference or referral. Such compensation amounts may be determined by any means necessary, including, but not limited to: the expected or actual value or revenue or benefit generated, charged or received by any affected or interested party, a fixed or variable amount, as determined by the person receiving such reference or referral, randomly, market forces, auction or other exchange or bidding service, or any combination of the forgoing. Compensation for such references or referrals may be made by any applicable means, including, any real or virtual: cash, credit card, barter, or any other real or virtual financial instrument, including a promise to pay or to perform services.

According to yet another embodiment, the present disclosure provides consultation services for virtual files. In one aspect of this embodiment, for services such as architectural critique or interior design, a client can upload a virtual file of a project that can then be used to render a virtual space. The professional can then log in to the virtual space, provide critique, and the virtual space can be altered based on the critique. The client can then download the file with the professional criticisms included.

According to yet another embodiment, the present disclosure provides a virtual environment including a camera that allows the client and virtual professional to see one another. In one aspect of this embodiment, a section of the GUI allows the professional and client to see one another. An additional fee can be charged for the privilege, and both parties must agree to allow the camera view to function.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

According to one embodiment, non-limiting exemplary programs and hardware/software architecture include:
Game Environment Server
Billing Server
Player Servers
Professional Servers
Court Server
Drug Issuance Server
Keyword Server
Search Engine Server
Professional Finder Server
Insurance Server
Prescription Server
Exchange Server

Access Authorization Database, which may provide a global method of regulating access to sensitive medical/billing or other information. This may also allow for matching of authorization access levels b/w player characters and data
Access authorization ID
Encryption level
Player ID (1-n)
Player character ID (1-n)
Single-use avatar ID (1-n)
Temporary alias ID (1-n)
Surrogate ID (1-n)
Player profile ID (1-n)
Player type ID (1-n)
Profession ID (1-n)
Professional ID (1-n)
Professional character ID (1-n)
License ID (1-n)
Permit ID (1-n)
Certification ID (1-n)
Activity ID (1-n)
Rating ID (1-n)

Player Database
Player ID
Social security number
First/last name
Personal info
Address
Login info
Preferences
Medical/psychological info
Prescription info
Financial account info
Insurance ID (1-n)
Outlook (and/or other scheduling program) account ID
Game level ID
Account created date/time
Account expiration date/time
Account modified date/time
Access authorization ID
Login info

Player Character Database
Player character ID
Player character alias
Player ID (1-n)
Player type ID (1-n)
Profile ID (1-n)
Personal info
Virtual address
Preferences
Virtual attributes
Medical/psychological info
Prescription info
Insurance ID (1-n)
Financial account info
Account created date/time
Account expiration date/time
Account modified date/time
Access authorization ID
Login info

Temporary Alias Database
Temporary alias ID
Player ID
Player character ID
Professional ID
Professional character ID
Player type ID (1-n)
Profile ID (1-n)
Personal info
Preferences
Virtual attributes
Medical/psychological info
Prescription info
Financial account info
Insurance ID (1-n)
Fee ID (1-n)
Alias activity info
Alias session info
Alias rules info
Alias created date/time
Alias expiration date/time
Alias modified date/time
Access authorization ID
Login info

Single-Use Avatar Database
Single-use avatar ID
Player ID
Player character ID
Professional ID
Professional character ID
Player type ID (1-n)
Profile ID (1-n)
Personal info
Preferences
Virtual attributes
Medical info
Prescription info
Psychological info
Financial account info
Insurance ID (1-n)
Fee ID
Avatar created date/time
Avatar expiration date/time
Avatar modified date/time
Access authorization ID
Login info

Surrogate Database
Surrogate ID
NPC ID
Surrogate activity profile
Player character ID
Surrogate certification/permit/license ID (1-n)
Player type ID (1-n)
Profile ID (1-n)
Personal info
Preferences
Virtual attributes
Medical info
Prescription info
Psychological info
Financial account info
Insurance ID (1-n)
Account created date/time
Account expiration date/time
Account modified date/time
Virtual location ID
Rules info
Fee ID
Access authorization ID
Login info

Non-Player Character (NPC) Database
NPC ID
NPC appearance rules
NPC behavior rules
NPC location coordinates
NPC use log
Insurance ID (1-n)
Virtual attributes
Activity ID
Player ID
Player character ID
Single-use avatar ID
Temporary alias ID
Access authorization ID
Login info

Surrogate Certification/Permit/License Database
Surrogate ID
Player ID
Player character ID
Surrogate rules
Surrogate location coordinates
Surrogate use log
Activity ID
Fee ID

Classification Database which may be configured to allow for the virtual professional to classify their clients according to pre-defined categories. For example, psychologists could classify clients according to pre-defined medical/psychological/etc. categories.
Medical/psychological classification ID
Medical/psychological classification name
Medical/psychological classification description
Activity ID (1-n)

Player Type Database
Player type ID
Player character ID
Player type name
Player type description
Activity ID (1-n)
Access authorization ID

Player Profile Database—may be based on player attributes, activities, history, location history, etc.
Profile ID
Profile title
Profile rank
Profile attributes
Player type ID (1-n)
Activity ID (1-n)
Session ID (1-n)
Location profile ID (1-n)
Access authorization ID

Activity Database
Activity ID
Player ID (1-n)
Player character ID (1-n)
Single-use avatar ID (1-n)
Temporary alias ID (1-n)
Surrogate ID (1-n)
Session ID (1-n)
Attributes (1-n)
Appointments ID (1-n)
Missions (1-n)
Parameters (1-n)
Virtual location ID (1-n)
Date/time
Access authorization ID

Player Sessions Database
Session ID
Professional ID (1-n)
Professional character ID (1-n)
Player ID (1-n)
Player character ID (1-n)
Temporary alias ID (1-n)
Single-use avatar ID (1-n)
Surrogate ID (1-n)
Activity ID
Virtual location ID
Date/time
Access authorization ID

Secret Entry Database
Secret entry ID
Player character ID (1-n)
Single-use avatar ID
Temporary alias ID
Surrogate ID
Entry location coordinates
Appointment ID
Appointment queue ID
Entry date/time
Access authorization ID

Secret Exit Database
Secret exit ID
Player character ID (1-n)
Single-use avatar ID
Temporary alias ID
Surrogate ID
Exit location coordinates
Appointment ID
Appointment queue ID
Exit date/time
Access authorization ID

Virtual Location Database
Virtual location ID
Player character ID
Temporary alias ID
Single-use avatar ID
Surrogate ID
Professional ID
Professional character ID
Virtual location coordinates
Access authorization ID

Location Profile Database—according to one embodiment, The “quality” of the environ may be calculated by the price of the real estate, the player characters who go there and the activities that they perform.
Location profile ID
Location profile rank
Player character ID (1-n)
Temporary alias ID (1-n)
Single-use avatar ID (1-n)
Activity ID (1-n)
Real estate location ID (1-n)
Business ID (1-n)
Advertising ID (1-n)
Access authorization ID

Real Estate Valuation Database
Real estate location ID
Real estate location coordinates
Real estate valuation
Access authorization ID
Profession Database
Profession ID
Profession name
Profession description
Licensor ID
Tax subsidy ID
Access authorization ID

Profession Suggestion Database which may allow a virtual professional to add new professional categories
Profession suggestion ID
Profession name
Profession description
Professional ID
Professional character ID
Player character ID
Single-use avatar ID
Temporary alias ID
Suggested date/time
Comments
Votes (1-n)
Access authorization ID

Profession Suggestion Queue Database
Profession suggestion queue ID
Profession suggestion ID
Rating (1-n)
Access authorization ID

Professional Database
Professional ID
Social security number
First/last name
Personal info
Virtual attributes
Preferences
Client criteria which may determine whether the client qualifies to see a professional
Address
Profession ID (1-n)
License ID (1-n)
Certification ID (1-n)
Skill ID (1-n)
Game level ID
Professional account info
Insurance ID (1-n)
Appointment ID (1-n)
Account created date/time
Account expiration date/time
Account modified date/time
Access authorization ID
Login info

Professional Character Database
Professional character ID
Professional character alias
Personal info
Virtual attributes
Preferences
Client criteria
Virtual address
Professional ID (1-n)
Profession ID (1-n)
License ID (1-n)
Rating ID (1-n)
Certification ID (1-n)
Insurance ID (1-n)
Skill ID (1-n)
Game level ID
Professional account info
Financial account info
Account created date/time
Account expiration date/time
Account modified date/time
Access authorization ID
Login info

Insurance Policy Database
Insurance policy ID
Insurance underwriter
Insurance issuer
Insurance name
Insurance type
Insurance deductible amount
Insurance co-pay amount
Insurance co-pay percentage
Insurance coverage limit
Insurance coverage rules
Insurance “in-network” attributes
Policy expiration date/time
Medical/psychological category ID (1-n) including, for example, whether or not conditions are covered by the insurance
Activity ID (1-n) including, for example, information regarding whether or not activities are covered by the insurance
Profile ID (1-n)
Fee ID including, for example, the cost of the insurance, monthly fees, etc.

Licensor Database
Licensor ID
License ID
Licensor association name
Licensor real world association name
Licensor contact information
Certifier ID (1-n)
Access authorization ID
Login info

Certification Panel Database
Certifier ID
Player ID (1-n)
Player character ID (1-n)
Professional ID (1-n)
Licensor ID (1-n)
Access authorization ID

Professional License Database
License ID
License name
License description
Licensor ID
Session ID (1-n)
Activity ID (1-n) may define the activities that can be performed under the auspices of the license; monitoring these activities allows the licensing agencies to revoke the licenses if necessary.
Medical/psychological classification ID may define the classification categories covered by the license, and may also enables regulationsCertification ID
Game level ID
Fee ID
Access authorization ID—grants licensed professionals access to certain, encrypted information.
Licensing association
Licensing rules
Rating ID—which may determine whether or not a license is revoked
License issued date/time
License expiration date/time
Access authorization ID

Professional Permit Database
Permit ID
Permit name
Permit description
Licensor ID
Permit rules
Rating ID
Session ID (1-n)
Permitted Activity ID (1-n)
Medical/psychological classification ID
Game level ID
Fee ID
Permit issued date/time
Permit expiration date/time
Access authorization ID—to grant licensed professionals access to certain, encrypted information.

Professional Certification Database
Certification ID
License ID (1-n)
Certifying association ID
Game level ID
Training course requirements
Certification issued date/time—allows for the establishment of a detailed Professional history, e.g., how long in practice, etc.
Certification expiration date/time
Access authorization ID

Professional Rating Database
Rating ID
Professional ID
Professional character ID
Rating score (e.g., on a scale of 1 to x)
Player character ID
Single-use avatar ID
Temporary alias ID
Comments (textual, audio and/or video)
Comment date/time
Survey ID (1-n)
Fee ID
Access authorization ID

Query Database—enables correspondence b/w patients and professionals.
Query ID
Profession ID—allows clients to query professionals by profession type, i.e., by “pool”
Professional ID
Professional character ID
Professional rating score—allows clients to query professionals by rating
Player character ID
Single-use avatar ID
Temporary alias ID
Query (textual, audio and/or video)
Query date/time
Fee ID
Access authorization ID

Query Response Database—allows professionals (and non-professionals) to respond to queries.
Query response ID
Query ID
Professional ID
Professional character ID
Player character ID
Single-use avatar ID
Temporary alias ID
Query response (textual, audio and/or video)
Query response date/time
Query bid price
Access authorization ID

Fee Database
Fee ID
Fee amount
Fee description
Discount amount/percentage
Service coupon ID (1-n)
Appointment location ID—account for cost discrepancies b/w offices or game environments
Tax ID
Tax subsidy ID
Access authorization ID

Credit Database
Credit ID
Player ID (1-n)
Player character ID (1-n)
Lending institution information
Credit terms and conditions
Credit preference ID (1-n)
Credit rule ID (1-n)
Fee ID
Access authorization ID

Credit Rules Database
Credit rule ID
Credit rule attributes
Access authorization ID

Credit Preferences Database
Credit preference ID
Credit preference attributes
Access authorization ID
Prepaid Code Database
Prepaid code ID
Prepaid amount
Fee ID
Player ID
Player character ID
Single-use avatar ID
Temporary alias ID
Profession ID (1-n)
Professional ID (1-n)
Professional character ID (1-n)
Access authorization ID

Service Coupon Database
Service coupon ID
Service coupon code
Discount amount/percentage
Coupon rule ID (1-n)
Professional ID
Professional character ID
Fee ID
Expiration date/time
Access authorization ID

Coupon Rules Database
Coupon rule ID
Coupon rule attributes
Profession ID (1-n)
Professional ID (1-n)
Professional character ID (1-n)
Player ID (1-n)
Player character ID (1-n)
Temporary alias ID (1-n)
Single-use avatar ID (1-n)
Player type ID (1-n)
Profile ID (1-n)
Activity ID (1-n)
Fee ID (1-n)
Access authorization ID

Calendar Database—Player/professionals can either be “owners” of the calendar or included in the calendar along with appointments.
Calendar ID
Calendar dates/times
Player ID (1-n)
Player character ID (1-n)
Temporary alias ID (1-n)
Single-use avatar ID (1-n)
Professional ID (1-n)
Professional character ID (1-n)
Appointment ID (1-n)
Court appointment ID (1-n)
Meeting ID (1-n)
Access authorization ID

Appointment Location Database
Appointment location ID
Appointment ID (1-n)
Appointment location name
Appointment location virtual/real coordinates
Appointment location environment (1-n)
Access authorization ID

Appointment Database
Appointment ID
Professional ID (1-n)
Professional character ID (1-n)
Player ID (1-n)
Player character ID (1-n)
Single-use avatar ID (1-n)
Temporary alias ID (1-n)
Surrogate ID (1-n)—allows surrogates/NPC to stand in for clients in waiting room queues.
NPC ID (1-n)
Fee ID (1-n)
Urgency rank (1-x)
Notoriety rank (1-x)
Sensitivity rank (1-x)
Appointment location ID
Appointment game server ID—identifies the game in which the appointment takes place
Appointment date/time scheduled
Appointment start date/time
Appointment end date/time
Appointment recurrence interval
Notes
Access authorization ID

Appointment Queue Database
Appointment queue ID
Appointment ID
Appointment priority (1-x)
Appointment gamer server ID
Appointment location ID—allows for filling up the calendar in one office/environment before another.
Access authorization ID

Appointment History Database
Appointment history ID
Appointment ID (1-n)
Professional character ID (1-n)
Player character ID (1-n)
Single-use avatar ID (1-n)
Temporary alias ID (1-n)
Access authorization ID

Meeting Database
Meeting ID
Appointment ID
Appointment location ID
Professional ID (1-n)
Professional character ID (1-n)
Player ID (1-n)
Player character ID (1-n)
Single-use avatar ID (1-n)
Temporary alias ID (1-n)
Prescription ID (1-n)
Fee ID (1-n)
Meeting duration
Textual transcript
Audio transcript
Video transcript
Professional rating ID (1-n)
Query ID (1-n)
Query response ID (1-n)
Survey ID (1-n)
Access authorization ID

Prescription Database
Prescription ID
Prescription name
Prescription dosage
Prescription refills (1-n)
Professional ID
Professional character ID
Player ID
Player character ID
Single-use avatar ID
Temporary alias ID
Medical/psychological classification ID
Prescription start date/time
Prescription end date/time
Access authorization ID

Government Database
Government ID
Jurisdiction ID (1-n)
Law/regulation ID (1-n)
Tax ID (1-n)
Tax subsidy ID (1-n)
Access authorization ID

Jurisdiction Database
Jurisdiction ID
Jurisdiction name
Location ID
Tax ID (1-n)
Access authorization ID

Tax Database
Tax ID
Tax name
Government ID (1-n)
Jurisdiction ID (1-n)
Fee ID
Access authorization ID

Tax Subsidy Database—tracks subsidies paid to certain professionals in order to make their services readily available to player characters.
Tax subsidy ID
Tax subsidy name
Profession ID—enables subsidies to certain groups of professionals
Professional ID—This enables subsidies to individual professionals, based on their meeting certain criteria, e.g., total number of hours of service provided
Professional character ID
Player type ID
Player profile ID—enables subsidies directly to certain types of players and player characters based on profile and other player data.
Player ID
Player character ID
Fee ID
Access authorization ID

Court Database
Court ID
Court name
Jurisdiction
Location ID
Access authorization ID

Court Appointment Database
Court appointment ID
Professional ID (1-n)
Professional character ID (1-n)
Player character ID (1-n)
Single-use avatar ID (1-n)
Temporary alias ID (1-n)
Fee ID (1-n)
Court ID
Court appointment start date/time
Court appointment end date/time
Access authorization ID

Laws & Regulations Database
Law/regulation ID
Law/regulation name
Law/regulation description
Penalty ID (1-n)
Profession ID (1-n)
Professional ID (1-n)
Professional character ID (1-n)
Player profile ID (1-n)
Player type ID (1-n)
Player ID
Player character ID (1-n)
Temporary alias ID (1-n)
Single-use avatar ID (1-n)
Surrogate ID (1-n)
Jurisdiction ID (1-n)
License ID (1-n)
Permit ID (1-n)
Activity ID (1-n)—identifies permitted/forbidden activities
Medical/psychological classification ID (1-n)
Law/regulation enactment date/time
Access authorization ID—allows a court to access certain virtual records

Penalty Database
Penalty ID
Penalty name
Penalty description
Activity ID (1-n)—identifies activities to be banned until professional help is obtained.
Penalty start date/time
Penalty end date/time
Law/regulation ID (1-n)
Profession ID
Professional ID
Professional character ID
Player ID
Player character ID
Single-use avatar ID
Temporary alias ID
Surrogate ID
Access authorization ID

Keyword Database
Keyword ID
Keyword/keyword phrase
Fee ID

Keyword Rules Database
Keyword rule ID
Keyword rule parameters
Keyword ID (1-n)
Virtual coordinates
Secret entry ID
Profession ID
Professional ID
Professional character ID
Player ID
Player character ID
Single-use avatar ID
Temporary alias ID
Surrogate ID
Player type ID
Profile ID
Activity ID

Advertisement Database
Advertisement ID
Advertisement parameters
Keyword ID
Fee ID

Advertisement Tracking Database
Advertisement tracking ID
Advertisement ID (1-n)
Profession ID
Professional ID
Professional character ID
Player ID
Player character ID
Single-use avatar ID
Temporary alias ID
Surrogate ID
Player type ID
Profile ID
Activity ID

Advertisement Billing Database
Advertisement billing ID
Advertisement ID
Advertisement tracking ID
Fee ID
Professional/professional character ID

Professional Finder Priority Ranking Database
Profession ID (1-n)
Professional ID (1-n)
Professional character ID (1-n)
License ID (1-n)
Permit ID (1-n)
Certification ID (1-n)
Rating ID (1-n)
Player ID (1-n)
Player character ID (1-n)
Single-use avatar ID (1-n)
Temporary alias ID (1-n)
Survey ID (1-n)
Fee ID (1-n)
Appointment queue ID (1-n)
Access authorization ID

Virtual Waiting Room Database
Waiting room ID
Waiting room status
Capacity (1-x)
Appointment ID (1-n) Links waiting rooms to specific appointments
Professional ID (1-n)—identifies waiting room by doctor
Professional character ID (1-n)
Profession ID (1-n)—identifies Waiting room by profession
Appointment location ID
Waiting room appearance ID
Access authorization ID

Virtual Waiting Room Appearance Database
Waiting room appearance ID
Waiting room dimensions
Waiting room characteristics
Access authorization ID

Virtual Waiting Room Queue Database
Waiting room queue ID
Appointment ID
Waiting room rank (1-n)
Waiting room ID
Fee ID
Arrival date/time
Access authorization ID

Office Appearance Database
Office appearance ID
Office dimensions
Office characteristics
Access authorization ID

Virtual Meeting Database
Virtual meeting ID
Virtual location coordinates
Appointment ID (1-n)
Player ID (1-n)
Player character ID (1-n)
Single-use avatar ID (1-n)
Temporary alias ID (1-n)
Professional ID (1-n)
Professional character ID (1-n)
Fee ID (1-n)
Waiting room appearance ID (I-n)
Office appearance ID (1-n)
Access authorization ID

Survey Template Database
Survey template ID
Survey template name
Survey template questions

Survey Database
Survey ID
Professional ID—Surveys issued by specific professional
Professional character ID
Profession ID—Surveys by profession type
Player ID
Player character ID
Single-use avatar ID
Temporary alias ID
Survey template ID (1-n)
Survey status
Access authorization ID

Contract Template Database
Contract template ID
Contract template terms & conditions
Law/regulation ID (1-n)
Jurisdiction ID (1-n)
Access authorization ID

Contract Database
Contract ID
Player ID
Player character ID
Temporary alias ID
Single-use avatar ID
Professional ID
Professional character ID
Contract template ID
Contract created date/time
Contract executed date/time
Access authorization ID

Contract Escrow Database
Escrow ID
Escrow date/time
Escrow amount
Contract ID
Fee ID

Camera Database
Camera ID
Camera usage log

Reference Database
Reference ID
Reference comments (1-n)
Player ID (1-n)
Player character ID (1-n)
Single-use avatar ID (1-n)
Temporary alias ID (1-n)
Surrogate ID (1-n)
Profile ID (1-n)
Player type ID (1-n)
Professional ID (1-n)
Professional character ID (1-n)
Access authorization ID

Virtual Records Database—enables continuous record-keeping across multiple, anonymous temp-alias or single-use avatar appointments
Virtual record ID
Player ID (1-n)
Player character ID (1-n)
Single-use avatar ID (1-n)
Temporary alias ID (1-n)
Surrogate ID (1-n)
Profile ID (1-n)
Player type ID (1-n)
Professional ID (1-n)
Professional character ID (1-n)
Activity ID (1-n)
Session ID (1-n)
Query ID (1-n)
Query response ID (1-n)
Survey ID (1-n)
Contract ID (1-n)
Meeting ID (1-n)
Appointment ID (1-n)
Appointment location ID (1-n)
Appointment history ID (1-n)
Virtual meeting ID (1-n)
Penalty ID (1-n)
Secret entry ID (1-n)
Secret exit ID (1-n)
Prescription ID (1-n)
Medical/psychological classification ID (1-n)
Fee ID (1-n)
Notes
Diagnosis/diagnoses
Symptoms
Textual and/or audio and/or video and/or other files
Access authorization ID

It will be appreciated that the various software and hardware components described above will be configured to perform a variety of functions and methods. Listed below are some non-limiting exemplary methods that might be performed by the systems as described herein:

General method
Create, setup and maintain initial databases
Determine if one or more of the following method steps, in whole or in part, should or must be performed
Perform steps as desired/required and in the order desired/required
Send one or more alerts as desired/required
Update databases as desired/necessary
Repeat the above steps as desired/necessary

Players/Player Characters
Create Player Account
Receive player social security number
Confirm player social security number uniqueness
Receive player first/last name
Receive player personal info
Receive player preferences
Receive player medical/psychological info
Receive player prescription info
Receive player financial account info
Calculate fees (if applicable)
Calculate taxes (if applicable)
Determine player financial account info
Generate invoice and/or deduct funds from player financial account
Generate player ID
Generate player account created date/time
Generate player account expiration date/time
Generate player account modified date/time
Generate player Access authorization ID
Generate player login info
Store player account

Create Player Character Account
Receive player login
Retrieve player ID
Retrieve access authorization ID
Confirm player access authorization
Receive player character first/last name and/or alias
Receive player character personal info
Receive player character preferences
Receive player character medical/psychological info
Receive player character prescription info
Receive player character financial account info
Confirm player character uniqueness
Calculate fees (if applicable)
Calculate taxes (if applicable)
Determine player financial account info
Generate invoice and/or deduct funds from player financial account
Generate player character ID
Generate account created date/time
Generate account expiration date/time
Generate account modified date/time
Generate Access authorization ID
Generate player character login info
Store player character account

Create Single-Use Avatar
Receive player/player character login
Receive player/player character ID
Retrieve access authorization ID
Confirm player/player character access authorization
Receive single-use avatar virtual attributes
Receive single-use avatar rules
Receive single-use avatar start date/time
Receive single-use avatar end date/time
Calculate single-use avatar fee (if applicable)
Calculate taxes (if applicable)
Retrieve player/player character financial account info
Bill player/player character and/or deduct funds from player/player character financial account
Deposit funds in tax accounts (if applicable)
Deposit funds in game server and/or other accounts
Generate single-use avatar
Issue single-use avatar on start date/time
Decommission single-use avatar on end date/time

Use Single-Use Avatar
Receive player/player character login
Retrieve player/player character ID
Retrieve access authorization ID
Confirm player/player character access authorization
Receive single-use avatar ID
Retrieve single-use avatar start date/time
Retrieve single-use avatar end date/time
Alert player/player character to single-use avatar start date/time
Accept player/player character acceptance
Activate single-use avatar control for player/player character
Determine NPC and/or surrogate rules (if applicable)
Activate NPC and/or surrogate (if applicable)
Alert player/player character to single-use avatar end date/time
Check for single-use avatar timeframe extension
Deactivate single-use avatar
Deactivate NPC and/or surrogate (if applicable)

Extend Single-Use Avatar Timeframe
Receive single-use avatar attributes
Retrieve single-use avatar ID
Confirm single-use avatar attributes
Receive new end date/time
Calculate single-use avatar extension fee (if applicable)
Calculate taxes (if applicable)
Retrieve player/player character financial account info
Bill player/player character and/or deduct funds from player/player character financial account
Deposit funds in tax accounts (if applicable)
Deposit funds in game server and/or other accounts
Update single-use avatar end date/time
Decommission single-use avatar on new end date/time

Exit Single-Use Avatar
Receive single-use avatar exit request and/or expiration notice
Retrieve single-use avatar ID
Retrieve player/player character ID
Retrieve player/player character financial account info
Calculate early-exit fees (if applicable)
Calculate taxes (if applicable)
Bill player/player character and/or deduct funds from player/player character financial account (if applicable)
Deposit funds in tax accounts (if applicable)
Deactivate single-use avatar
Deactivate NPC and/or surrogate (if applicable)

Create Temporary Alias
Receive player/player character login
Retrieve player/player character ID
Retrieve access authorization ID
Confirm player/player character access authorization
Receive temporary alias virtual attributes
Receive temporary alias rules
Receive temporary alias start date/time
Receive temporary alias end date/time
Calculate temporary alias fee (if applicable)
Calculate taxes (if applicable)
Retrieve player/player character financial account info
Bill player/player character and/or deduct funds from player/player character financial account
Deposit funds in tax accounts (if applicable)
Deposit funds in game server and/or other accounts
Generate temporary alias
Issue temporary alias on start date/time
Decommission temporary alias on end date/time

Use Temporary Alias
Receive player/player character login
Retrieve player/player character ID
Retrieve access authorization ID
Confirm player/player character access authorization
Retrieve temporary alias ID
Retrieve temporary alias start date/time
Retrieve temporary alias end date/time
Alert player/player character of temporary alias start date/time
Accept player/player character acceptance
Activate temporary alias control for player/player character
Determine NPC and/or surrogate rules (if applicable)
Activate NPC and/or surrogate (if applicable)
Alert player/player character to temporary alias end date/time
Check for temporary alias timeframe extension
Deactivate temporary alias
Deactivate NPC and/or surrogate (if applicable)

Extend Temporary Alias Timeframe
Receive temporary alias attributes
Retrieve temporary alias ID
Confirm temporary alias attributes
Receive new end date/time
Calculate temporary alias fee (if applicable)
Calculate taxes (if applicable)
Retrieve player/player character financial account info
Bill player/player character and/or deduct funds from player/player character financial account
Deposit funds in tax accounts (if applicable)
Deposit funds in game server and/or other accounts
Update temporary alias end date/time
Decommission temporary alias on new end date/time

Exit Temporary Alias
Receive temporary alias exit request and/or expiration notice
Retrieve temporary alias ID
Retrieve player/player character ID
Retrieve player/player character financial account info
Calculate early-exit fees (if applicable)
Calculate taxes (if applicable)
Bill player/player character and/or deduct funds from player/player character financial account (if applicable)
Deposit funds in tax accounts (if applicable)
Deactivate temporary alias
Deactivate NPC and/or surrogate (if applicable)

Create Surrogate
Receive player/player character login
Retrieve player/player character ID
Retrieve access authorization ID
Confirm player/player character access authorization
Receive surrogate virtual attributes
Receive surrogate rules
Receive surrogate start date/time
Receive surrogate end date/time
Calculate surrogate fee (if applicable)
Calculate taxes (if applicable)
Retrieve player/player character financial account info
Bill player/player character and/or deduct funds from player/player character financial account
Deposit funds in tax accounts (if applicable)
Deposit funds in game server and/or other accounts
Generate surrogate
Issue surrogate on start date/time
Decommission surrogate on end date/time

Use Surrogate
Receive player/player character login
Retrieve player/player character ID
Retrieve access authorization ID
Confirm player/player character access authorization
Receive surrogate ID
Retrieve surrogate start date/time
Retrieve surrogate end date/time
Retrieve player/player character ID
Alert player/player character to surrogate start date/time
Accept player/player character acceptance
Activate surrogate control for player / player character
Determine NPC and/or surrogate rules (if applicable)
Activate NPC and/or surrogate (if applicable)
Alert player/player character to surrogate end date/time
Check for surrogate timeframe extension
Deactivate surrogate
Deactivate NPC and/or surrogate (if applicable)
Determine fee ID (if applicable)
Generate invoice and/or deduct funds from player/player character/temporary alias/single-use avatar and/or insurance accounts (if applicable)
Bid for a Surrogate
Receive surrogate name/attributes
Confirm surrogate name/attributes
Receive surrogate bid start date/time
Receive surrogate bid end date/time
Receive bid amount
Generate surrogate bid queue ID

Set Up Surrogate Rules
Receive surrogate attributes
Retrieve surrogate ID
Confirm surrogate attributes
Receive player/player character ID
Confirm player/player character association with surrogate
Receive surrogate rule parameters
Receive surrogate virtual location parameters
Receive surrogate start date/time
Receive surrogate end date/time

Surrogate Behaves Using Rules
Receive surrogate ID
Retrieve surrogate rule parameters
Retrieve corresponding activity ID (1-n)
Limit surrogate behavior to corresponding activity ID (1-n)

Surrogate Sends Alert
Receive activity ID
Receive surrogate ID
Retrieve surrogate rules
Retrieve player/player character ID
Alert player/player character

Certify Professional
Receive a Professional application, including Professional personal info, Profession ID, application fees, and Proof of Professional Credentials
Determine if there is an available permit/license for Profession ID
Output the application for an approval score
Retrieve/Generate approval score
Determine if approval score qualifies application to be accepted
Determine limit on number of appointments (if applicable)
Accept application
Determine fees
Output application acceptance plus fee amount to professional
Receive fee amount from professional
Create Professional record, including Professional ID, personal info, and credentials
Generate/Retrieve License/Permit number
Assign permit number to Professional ID
Activate Professional account

Renew Professional Certification
Receive professional login
Retrieve professional ID
Retrieve access authorization ID
Confirm professional access authorization
Retrieve profession ID
Retrieve account details
Retrieve license ID(s)
Verify valid professional license(s)
Retrieve player comments
Retrieve rating score(s)
Retrieve court records
Retrieve penalty records
Retrieve activity records
Retrieve fee records
Generate professional overview report
Retrieve licensing agency information (if applicable)
Export overview report to licensing entities (if applicable)
Receive licensing entity response(s) (if applicable)
Verify licensing entity participation (if applicable)
Retrieve licensing requirements
Verify licensing requirements met
Determine limit on number of appointments (if applicable)
Calculate certification fees (if applicable)
Calculate taxes (if applicable)
Determine professional/professional character financial account info
Generate invoice and/or deduct funds from professional/professional character financial account
Deposit funds in tax accounts (if applicable)
Deposit funds in licensing and/or certifying agency account(s)
Generate valid license ID
Generate license expiration date/time
Store professional certification information
Notify professional

Automated Certification Process
Receive automated certification trigger (e.g., game stage ID, activity ID, certification expiration date/time etc.)
Retrieve player/player character/temporary alias/single-use avatar/professional/professional character ID
Retrieve profession ID (1-n)
Retrieve certification ID (1-n) (if applicable)
Receive professional license application
Determine if there is an available permit/license for Profession ID
Retrieve licensor and/or certification panel ID (1-n)
Output the application for an approval score
Retrieve/generate approval score
Determine if approval score qualifies application to be accepted
Determine limit on number of appointments (if applicable)
Accept application
Calculate fees (if applicable)
Calculate taxes (if applicable)
Deposit funds in tax accounts (if applicable)
Determine professional financial account info
Generate invoice and/or deduct funds from professional financial account (if applicable)
Generate professional license ID
Generate license created date/time
Generate license expiration date/time
Generate access authorization ID
Activate approved activity ID (1-n)
Alert professional to license acceptance or denial

Issue Professional License
Receive professional personal info
Retrieve profession ID (1-n)
Retrieve certification ID (1-n)
Receive professional license application
Determine if there is an available permit/license for Profession ID
Retrieve licensor and/or certification panel ID (1-n)
Output the application for an approval score
Retrieve/generate approval score
Determine if approval score qualifies application to be accepted
Determine limit on number of appointments (if applicable)
Accept application
Calculate fees (if applicable)
Calculate taxes (if applicable)
Deposit funds in tax accounts (if applicable)
Determine professional financial account info
Generate invoice and/or deduct funds from professional financial account (if applicable)
Generate professional license ID
Generate license created date/time
Generate license expiration date/time
Generate access authorization ID
Activate approved activity ID (1-n)
Alert professional to license acceptance or denial

Track Usage of License
Receive/retrieve license ID
Retrieve professional/professional character ID
Retrieve appointment ID (1-n)
Retrieve activity ID (1-n)
Retrieve meeting ID (1-n)
Generate license usage summary report
Generate alerts for unlicensed activities (if applicable)

Create Professional Character Account
Receive professional login
Retrieve professional ID
Retrieve access authorization ID
Confirm professional access authorization
Receive professional character first/last name and/or alias
Receive professional character personal info
Receive professional character financial account info
Receive professional character preferences
Receive professional character profession (1-n)
Receive professional character certification info (1-n)
Receive professional character license info (1-n)
Receive professional character permit info (1-n)
Receive professional character skill level
Receive professional character game level
Confirm professional character uniqueness
Calculate fees (if applicable)
Calculate taxes (if applicable)
Deposit funds in tax accounts (if applicable)
Determine professional financial account info
Generate invoice and/or deduct funds from professional financial account
Generate professional character ID
Generate account created date/time
Generate account expiration date/time
Generate Access authorization ID
Generate professional character login info

Rate Professional
Receive player/player character/temporary alias/single-use avatar login info
Retrieve player/player character/temporary alias/single-use avatar ID
Confirm player/player character/temporary alias/single-use avatar identity
Receive professional/professional character name
Retrieve professional/professional character ID
Confirm professional/professional character
Receive professional rating score
Calculate fees (if applicable)
Calculate taxes (if applicable)
Deposit funds in tax accounts (if applicable)
Determine player/player character/temporary alias/single-use avatar financial account info
Generate invoice and/or deduct funds from player/player character/temporary alias/single-use avatar financial account
Submit professional rating score
Create Reference Application
Receive player/player character/temporary alias/single-use avatar/professional/professional character login info
Retrieve player/player character/temporary alias/single-use avatar/professional/professional character ID
Confirm player/player character/temporary alias/single-use avatar/professional/professional character identity
Receive professional/professional character name
Retrieve professional/professional character ID
Confirm professional/professional character
Receive reference application
Generate reference application ID

Accept or Deny Reference Application
Receive professional/professional character login
Retrieve professional/professional character ID
Retrieve access authorization ID
Confirm professional/professional character access authorization
Retrieve reference application ID
Notify professional/professional character of new reference
Receive professional/professional character acceptance or denial of reference application
Generate reference ID (if applicable)

Generate Fees for References
Receive appointment ID
Retrieve reference ID
Retrieve fee ID
Calculate referral fees (if applicable)
Calculate taxes (if applicable)
Deposit funds in tax accounts (if applicable)
Determine professional/professional character financial account info
Deduct funds from professional/professional character financial account
Determine referrer financial account info
Deposit funds to referrer financial account and/or provide credit or other benefit

Categories
Suggest Professional Category
   Receive professional/professional character/player/player character/temporary alias/single-use avatar login info
   Retrieve professional/professional character/player/player character/temporary alias/single-use avatar ID
   Retrieve access authorization ID
   Confirm professional/professional character/player/player character/temporary alias/single-use access authorization
   Receive profession suggestion title
   Receive comment text and/or audio and/or video
   Retrieve profession licensing entity contact info
   Calculate fees (if applicable)
   Calculate taxes (if applicable)
   Determine professional/professional character/player/player character/temporary alias/single-use avatar financial account info
   Generate invoice and/or deduct funds from professional/professional character/player/player character/temporary alias/single-use avatar financial account
   Submit profession suggestion to applicable recipient(s)
Accept New Professional Category
   Receive profession suggestion acceptance votes from applicable recipient(s)
   Confirm participation of all applicable recipient(s)
   Generate profession ID
   Add profession title to list of certified professions
Suggest New Medical/Psychological Category
   Receive professional/professional character/player/player character/temporary alias/single-use avatar login info
   Retrieve professional/professional character/player/player character/temporary alias/single-use avatar ID
   Retrieve access authorization ID
   Confirm professional/professional character/player/player character/temporary alias/single-use access authorization
   Receive medical/psychological category suggestion title
   Receive comment text and/or audio and/or video
   Retrieve profession licensing entity contact info
   Calculate fees (if applicable)
   Calculate taxes (if applicable)
   Determine professional/professional character/player/player character/temporary alias/single-use avatar financial account info
   Generate invoice and/or deduct funds from professional/professional character/player/player character/temporary alias/single-use avatar financial account
   Submit medical/psychological category suggestion to applicable recipient(s)
Accept New Medical/Psychological Category
   Receive medical/psychological category suggestion acceptance votes from applicable recipient(s)
   Confirm participation of all applicable recipient(s)
   Generate medical/psychological category ID
   Add medical/psychological category title to list of certified medical/psychological category titles

Appointments
Schedule Appointment
   Receive appointment start date/time
   Receive appointment end date/time
   Receive appointment recurrence interval (if applicable)
   Receive appointment location attributes (real and/or virtual)
   Receive referral information (if applicable)
   Receive reference information (if applicable)
   Receive professional/professional character name
   Retrieve professional/professional character ID
   Confirm professional/professional character identity
   Output additional information (if applicable)
   Receive player/player character/temporary alias/single-use avatar name
   Retrieve player/player character/temporary alias/single-use avatar ID
   Retrieve access authorization ID
   Confirm player/player character/temporary alias/single-use access authorization
   Request more information (if applicable)
   Retrieve player/player character/temporary alias/single-use avatar insurance account info
   Determine insurance in-network status (if applicable)
   Determine appointment conflicts
   Generate appointment ID
   Retrieve calendar ID (1-n)
   Add appointment to relevant calendar(s) (if applicable)
   Retrieve appointment queue ID
   Add appointment to appointment queue or generate appointment queue ID
   Generate appointment notifications (e.g. i.e., calendar entries, including Outlook)
Bid for Appointment
   Receive appointment start date/time
   Receive appointment end date/time
   Receive professional/professional character name
   Retrieve professional/professional character ID
   Retrieve appointment ID
   Confirm appointment attributes
   Output current bid amounts
   Receive bid amount
   Update bid amount
Bill for Appointment
   Receive appointment ID
   Retrieve player/player character/temporary alias/single-use avatar ID (1-n)
   Retrieve player/player character/temporary alias/single-use avatar financial account info
   Retrieve fee ID (1-n)
   Retrieve insurance ID (1-n)
   Determine insurance coverage (if applicable)
   Calculate taxes (if applicable)
   Verify virtual service subscription plan (if applicable)
   Generate invoice and/or deduct funds from player/player character/temporary alias/single-use avatar and/or insurance accounts (if applicable)
   Retrieve professional/professional character ID
   Determine professional/professional character financial account info
   Deposit funds in professional/professional character account(s) (if applicable)
   Deposit funds in tax accounts (if applicable)
   Deposit funds in licensing and/or certifying agency account(s) (if applicable)
Subscribe to Virtual Service
   Receive profession type
   Retrieve profession ID
   Receive professional/professional character name
   Retrieve professional/professional character ID
   Confirm professional/professional character identity
   Receive subscription plan
   Receive referral information (if applicable)
   Receive reference information (if applicable)
   Receive player/player character/temporary alias/single-use avatar name
   Retrieve player/player character/temporary alias/single-use avatar ID
   Confirm player/player character/temporary alias/single-use avatar identity
   Retrieve player/player character/temporary alias/single-use avatar insurance account info
   Determine insurance in-network status (if applicable)
   Retrieve fee ID (1-n)
   Retrieve insurance ID (1-n)
   Determine insurance coverage (if applicable)
   Calculate taxes (if applicable)
   Generate recurring invoice and/or deduct funds from player/player character/temporary alias/single-use avatar and/or insurance accounts (if applicable)
   Retrieve professional/professional character ID
   Determine professional/professional character financial account info
   Deposit funds in professional/professional character account(s) (if applicable)
   Deposit funds in tax accounts (if applicable)
   Deposit funds in licensing and/or certifying agency account(s) (if applicable)
Create Appointment Queue
   Receive appointment ID
   Retrieve professional/professional character ID (1-n)
   Generate appointment queue ID
   Place appointment in queue
Queue Appointments
   Receive appointment ID
   Retrieve appointment sensitivity rank (1-x)
   Retrieve appointment notoriety rank (1-x)
   Retrieve appointment urgency rank (1-x)
   Retrieve fee ID (1-n)
   Calculate appointment priority rank
   Generate appointment queue ID
   Generate appointment start date/time
   Generate appointment end date/time
Generate Appointment Invoice
   Receive appointment ID
   Retrieve fee ID
   Retrieve player/player character/single-use avatar/temporary alias ID (1-n)
   Retrieve professional/professional character ID (1-n)
   Retrieve appointment start date/time
   Retrieve appointment end date/time
   Calculate appointment fee
   Retrieve insurance ID (1-n)
   Determine insurance coverage (if applicable)
   Calculate taxes (if applicable)
   Generate appointment invoice
   Output appointment invoice to player/player character/single-use avatar/temporary alias
Release real names after Appointment reaches appropriate point
   Receive request for release of real names and/or appointment schedule
   Retrieve appointment ID
   Retrieve player character/temporary alias/single-use avatar ID (1-n)
   Retrieve player ID (1-n)
   Retrieve player personal info and/or first/last name
   Submit player name to professional/professional character (if applicable)
   Retrieve professional character ID (1-n)
   Retrieve professional ID (1-n)
   Retrieve professional personal info and/or first/last name
   Output professional name to player/player character
Provide Reduced Rate Appointment
   Receive appointment ID
   Retrieve fee ID
   Retrieve player/player character/single-use avatar/temporary alias ID (1-n)
   Retrieve professional/professional character ID (1-n)
   Retrieve appointment start date/time
   Retrieve appointment end date/time
   Calculate appointment fee
   Calculate reduced rate discount
   Retrieve insurance ID (1-n)
   Determine insurance coverage (if applicable)
   Calculate taxes (if applicable)
   Generate appointment invoice
   Output appointment invoice to player/player character/single-use avatar/temporary alias ‘Create Appointment Contract
   Receive appointment ID
   Retrieve player/player character/temporary alias/single-use avatar ID (1-n)
   Retrieve professional/professional character ID (1-n)
   Retrieve location ID
   Retrieve jurisdiction ID
   Retrieve start date/time
   Retrieve end date/time
   Retrieve fee ID
   Retrieve contract template ID
   Generate contract ID
Provide Contract Benefit When Appointment is Complete
   Receive appointment end date/time
   Confirm appointment end date/time
   Retrieve appointment ID
   Retrieve contract ID
   Retrieve player/player character/single-use avatar/temporary alias ID (1-n)
   Output contract benefit and/or contract benefit information to player/player character/single-use avatar/temporary alias
Notify Client That It is Time for Appointment
   Retrieve appointment ID
   Retrieve appointment start date/time
   Retrieve player/player character/single-use avatar/temporary alias ID (1-n)
   Retrieve player/player character/single-use avatar/temporary alias personal info
   Generate appointment notification
   Output appointment notification to player/player character/single-use avatar/temporary alias
Notify Client of Queue Position
   Retrieve appointment ID
   Retrieve appointment queue ID
   Retrieve player/player character/single-use avatar/temporary alias ID (1-n)
   Retrieve player/player character/single-use avatar/temporary alias personal info
   Generate appointment queue notification
   Output appointment queue notification to player/player character/single-use avatar/temporary alias
Output Queue to Professional
   Receive appointment queue request
   Retrieve appointment queue ID
   Retrieve appointment ID (1-n)
   Retrieve appointment details
Determine if appointment can occur based on real world jurisdiction of appointment players
   Receive appointment ID
   Retrieve player ID (1-n)
   Retrieve professional ID (1-n)
   Retrieve jurisdiction information
   Calculate jurisdiction correspondence
   Output appointment alert (if applicable)
Schedule Appointments for a Professional on Multiple Game Servers Based on Rules
   Receive appointment date/time
   Receive appointment game server name
   Retrieve game server ID
   Confirm game server attributes
   Receive appointment location attributes
   Receive referral information
   Receive professional/professional character name
   Retrieve professional/professional character ID
   Receive player/player character/temporary alias/single-use avatar account info
   Retrieve player/player character/temporary alias/single-use avatar ID
   Retrieve player/player character/temporary alias/single-use avatar insurance account info
   Determine insurance in-network status (if applicable)
   Determine appointment conflicts
   Generate appointment ID
   Generate appointment queue ID
Manage Appointments Based on Laws/Regulations and/or Rules
   Receive appointment ID
   Retrieve player/player character/single-use avatar/temporary alias ID (1-n)
   Retrieve professional/professional character ID (1-n)
   Retrieve professional/professional character certification ID (1-n)
   Retrieve virtual location coordinates
   Retrieve jurisdiction ID (1-n)
   Retrieve law/regulation ID (1-n)
   Retrieve rule ID (1-n)
   Determine whether appointment can occur
   Determine permissible activity ID (1-n) in appointment
   Monitor appointment activity ID (1-n)
   Generate alert for non-permitted activity ID
   Output activity alerts to monitoring agency (if applicable)
Alter Client and/or Professional Avatar Based on Appointment
   Receive appointment ID
   Retrieve player/player character/single-use avatar/temporary alias ID (1-n)
   Retrieve player character/single-use avatar/temporary alias virtual attributes
   Retrieve professional/professional character ID (1-n)
   Retrieve professional character virtual attributes
   Modify professional character virtual attributes according to preferences (if applicable)
   Modify player character/single-use avatar/temporary alias virtual attributes according to preferences (if applicable)
Submit Code to Access Encrypted Appointment
   Receive player/player character/single-use avatar/temporary alias/professional/professional character/ other ID
   Retrieve Access authorization ID
   Receive appointment ID
   Retrieve meeting ID
   Retrieve access authorization ID
   Receive access authorization code
   Grant or deny access authorization to meeting record
Create Credits in Exchange for Providing Professional Appointments
   Receive appointment ID
   Retrieve player/player character/temporary alias/single-use avatar ID (1-n)
   Retrieve player/player character/temporary alias/single-use avatar financial account info
   Retrieve fee ID (1-n)
   Retrieve insurance ID (1-n)
   Determine insurance coverage (if applicable)
   Calculate taxes (if applicable)
   Generate credit(s) for goods and/or services
   Retrieve professional/professional character ID
   Determine professional/professional character financial account info
   Transfer credit(s) to professional/professional character account(s)
   Deposit funds in tax accounts (if applicable)
   Deposit funds in licensing and/or certifying agency account(s) (if applicable)

Create Real World Appointment During Virtual World Appointment
Receive appointment date/time
Receive appointment location attributes (real and/or virtual)
Receive referral information (if applicable)
Receive professional/professional character name
Retrieve professional/professional character ID
Confirm professional/professional character identity
Request more information (if applicable)
Receive player/player character/temporary alias/single-use avatar name
Retrieve player/player character/temporary alias/single-use avatar ID
Confirm player/player character/temporary alias/single-use avatar identity
Request more information (if applicable)
Retrieve player/player character/temporary alias/single-use avatar insurance account info
Determine insurance in-network status (if applicable)
Determine appointment conflicts
Generate appointment ID
Generate appointment queue ID
Generate appointment notifications
Generate appointment notifications

Link Virtual World Appointments to Outlook
Retrieve appointment ID
Retrieve appointment start date/time
Retrieve player/player character/single-use avatar/temporary alias ID (1-n)
Retrieve player/player character/single-use avatar/temporary alias Outlook account
Generate appointment notification
Output appointment notification to player Outlook account

Provide Camera View in Appointment
Receive appointment ID
Retrieve camera ID (1-n)
Retrieve player/player character/temporary alias/single-use avatar/professional/professional character ID (1-n)
Output camera view to player/player character/temporary alias/single-use avatar/professional/professional character

Queries
Issue Query
   Receive player/player character/temporary alias/single-use avatar login info
   Retrieve player/player character/temporary alias/single-use avatar ID
   Confirm player/player character/temporary alias/single-use avatar identity
   Receive query recipient name and/or profession type and/or profile
   Receive query text and/or audio and/or video and/or other files
   Calculate fees (if applicable)
   Calculate taxes (if applicable)
   Determine player/player character/temporary alias/single-use avatar financial account info
   Generate invoice and/or deduct funds from player/player character/temporary alias/single-use avatar financial account
   Retrieve query recipient contact info
   Submit query to applicable recipient(s)
   Submit query receipt to sender (if applicable)
Respond to Query
   Receive professional/professional character/player/player character/temporary alias/single-use avatar login info
   Retrieve professional/professional character/player/player character/temporary alias/single-use avatar ID
   Confirm professional/professional character/player/player character/temporary alias/single-use avatar identity
   Receive query response text and/or audio and/or video and/or other files
   Calculate fees (if applicable)
   Calculate taxes (if applicable)
   Determine professional/professional character/player/player character/temporary alias/single-use avatar financial account info
   Generate invoice and/or deduct funds from professional/professional character/player/player character/temporary alias/single-use avatar financial account
   Retrieve query response recipient (i.e., query issuer) contact info
   Submit query to applicable recipient(s)

Virtual Locations
Create Virtual Location
   Receive virtual location coordinates
   Receive virtual location attributes
   Receive virtual location start date/time
   Receive virtual location end date/time
   Verify virtual location availability
   Receive professional and/or professional character ID (I-n)
   Calculate virtual location fee
   Generate fee ID
   Calculate taxes (if applicable)
   Retrieve professional/professional character financial account info
   Bill professional/professional character and/or deduct funds from professional/professional character financial account
   Deposit funds in tax accounts (if applicable)
   Deposit funds in game server and/or other accounts (if applicable)
   Issue virtual location ID
Track Virtual Location
   Receive player/player character/temporary alias/single-use avatar/surrogate/NPC/professional/professional character ID
   Retrieve virtual location/coordinates
   Record virtual location/coordinates
Create Secret Entry/Exit
   Receive secret entry/exit location coordinates
   Receive secret entry/exit date/time
   Verify secret entry/exit availability
   Receive player/player character/single-use avatar/temporary alias/professional/professional character ID (1-n)
   Calculate secret entry/exit fee
   Generate fee ID
   Calculate taxes (if applicable)
   Retrieve player/player character/single-use avatar/temporary alias/professional/professional character financial account info
   Bill player/player character/single-use avatar/temporary alias/professional/professional character and/or deduct funds from player/player character/single-use avatar/temporary alias/professional/professional character financial account
   Deposit funds in tax accounts (if applicable)
   Deposit funds in game server and/or other accounts (if applicable)
   Issue secret entry/exit ID
Use Secret Entry/Exit
   Retrieve secret entry/exit ID
   Retrieve secret entry/exit date/time
   Retrieve secret entry/exit coordinates
   Retrieve player/player character/single-use avatar/temporary alias/professional/professional character ID (1-n)
   Alert player/player character/single-use avatar/temporary alias/professional/professional character to relocation countdown
   Relocate player/player character/single-use avatar/temporary alias/professional/professional character to secret entry/exit location

Advertisements
Purchase keyword advertisement
   Receive keyword phrase
   Retrieve keyword bids
   Output current keyword bids
   Receive keyword bid
   Receive keyword advertisement location and/or rules
   Receive keyword advertisement start date/time
   Receive keyword advertisement end date/time
   Receive professional/professional character info
   Calculate taxes (if applicable)
   Retrieve professional/professional character financial account info
   Bill professional/professional character and/or deduct funds from professional/professional character financial account
   Deposit funds in tax accounts (if applicable)
   Deposit funds in game server and/or other accounts (if applicable)
   Generate keyword advertisement ID
Display keyword advertisement
   Receive keyword advertisement ID
   Retrieve keyword advertisement location and/or rules
   Retrieve keyword advertisement start date/time
   Retrieve keyword advertisement end date/time
   Verify keyword advertisement fee paid and/or bill or invoice professional/professional character
   Display keyword advertisement
Click on keyword advertisement to go to office
   Receive keyword advertisement click
   Retrieve keyword advertisement ID
   Retrieve keyword advertisement location and/or rules
   Output relocation request
   Receive relocation acceptance
   Relocate player/player character/temporary alias/single-use avatar to virtual location
   Retrieve bid amount
   Generate fee ID
Determine if keyword ad can be displayed based on professional log in and Appointment queue
   Receive professional/professional character name
   Receive professional/professional character availability start date/time
   Receive professional/professional character availability end date/time
   Retrieve professional/professional character appointment queue ID
   Calculate professional/professional character availability
   Retrieve advertising billing ID (1-n)
   Retrieve professional/professional character financial account info
   Verify available funds
   Retrieve advertisement ID (1-n)
   Activate advertisement ID (1-n) (if applicable)
Generate Interstitial Ad to Player for Services Based on Play Activity
   Receive activity ID
   Receive player/player character/single-use avatar/temporary alias/professional/professional character ID
   Retrieve player/player character/single-use avatar/temporary alias/professional/professional character preferences
   Retrieve player/player character/single-use avatar/temporary alias/professional/professional character profile ID (1-n)
   Retrieve player/player character/single-use avatar/temporary alias/professional/professional character type ID (1-n)
   Retrieve player/player character/single-use avatar/temporary alias/professional/professional character virtual attributes
   Retrieve relevant interstitial ads
   Output interstitial ads

Prepaid Codes
Create Prepaid Code
   Receive player/player character/temporary alias/single-use avatar info
   Retrieve player/player character/temporary alias/single-use avatar ID (1-n)
   Receive prepaid code amount
   Generate fee ID
   Calculate taxes (if applicable)
   Retrieve player/player character/single-use avatar/temporary alias financial account info
   Bill player/player character/single-use avatar/temporary alias and/or deduct funds from player/player character/single-use avatar/temporary alias financial account
   Deposit funds in tax accounts (if applicable)
   Deposit funds in game server and/or other accounts (if applicable)
   Issue prepaid code ID
Use Prepaid Code
   Receive prepaid code ID
   Retrieve prepaid code amount
   Receive appointment info
   Retrieve appointment ID
   Retrieve fee ID (1-n)
   Calculate prepaid code deduction
   Calculate taxes (if applicable)
   Retrieve player/player character/single-use avatar/temporary alias financial account info
   Bill player/player character/single-use avatar/temporary alias and/or deduct funds from player/player character/single-use avatar/temporary alias financial account
   Deposit funds in tax accounts (if applicable)
   Deposit funds in game server and/or other accounts (if applicable)

Coupons
Create Coupon
   Receive professional/professional character info
   Retrieve professional/professional character ID (1-n)
   Receive coupon start date/time
   Receive coupon end date/time
   Receive coupon discount amount
   Receive coupon discount attributes
   Generate fee ID
   Calculate taxes (if applicable)
   Retrieve professional/professional character financial account info
   Bill professional/professional character and/or deduct funds from professional/professional character financial account
   Deposit funds in tax accounts (if applicable)
   Deposit funds in game server and/or other accounts (if applicable)
   Generate coupon ID
Redeem Coupon
   Receive coupon ID
   Retrieve coupon amount
   Receive appointment info
   Retrieve appointment ID
   Retrieve fee ID (1-n)
   Calculate coupon deduction
   Calculate taxes (if applicable)
   Retrieve player/player character/single-use avatar/temporary alias financial account info
   Bill player/player character/single-use avatar/temporary alias and/or deduct funds from player/player character/single-use avatar/temporary alias financial account
   Deposit funds in tax accounts (if applicable)
   Deposit funds in game server and/or other accounts (if applicable)
   Find Professional/Match Player
Find Virtual Professional
   Receive player/player character/temporary alias/single-use avatar personal info and/or ID
   Retrieve player/player character/temporary alias/single-use avatar profile ID
   Receive profession type (1-n)
   Retrieve profession ID (1-n)
   Receive certification type (1-n)
   Retrieve certification ID (1-n)
   Receive medical/psychological category type (1-n)
   Retrieve medical/psychological category ID (1-n)
   Receive other search criteria
   Retrieve relevant professional/professional character ID (1-n)
   Retrieve professional/professional character ratings
   Calculate relevancy
   Display professional/professional character information according to search criteria
   Display professional/professional character schedule information
   Schedule appointment (if applicable)
Pay To Be Listed as Professional
   Receive professional/professional character info
   Retrieve professional/professional character ID
   Confirm professional/professional character identity
   Receive display start date/time
   Receive display end date/time
   Retrieve appointment queue ID
   Retrieve fee ID
   Calculate taxes
   Retrieve professional/professional character financial account info
   Bill professional/professional character and/or deduct funds from professional/professional character financial account
   Deposit funds in tax accounts (if applicable)
   Deposit funds in game server and/or other accounts (if applicable)
   Generate professional listing ID
   Output professional listing based on parameters and appointment availability
Suggest Professional to Client Based on Play History/Profile
   Receive player/player character/temporary alias/single-use avatar personal info and/or ID
   Retrieve player/player character/temporary alias/single-use avatar profile ID
   Retrieve player/player character/temporary alias/single-use avatar medical/psychological category ID (1-n)
   Retrieve professional/professional character ID (1-n)
   Retrieve professional/professional character ratings
   Calculate relevancy to player/player character/temporary alias/single-use avatar
   Display professional/professional character information according to search criteria
   Display professional/professional character schedule information
   Schedule appointment (if applicable)
Determine if Client Qualifies to See a Professional
   Receive player/player character/single-use avatar/temporary alias ID
   Retrieve player/player character/single-use avatar/temporary alias type ID (1-n)
   Retrieve player/player character/single-use avatar/temporary alias profile ID (1-n)
   Retrieve player/player character/single-use avatar/temporary alias preferences
   Retrieve player/player character/single-use avatar/temporary alias personal info
   Retrieve player/player character/single-use avatar/temporary alias medical/psychological category ID (1-n)
   Retrieve player/player character/single-use avatar/temporary alias prescription ID (1-n)
   Retrieve player/player character/single-use avatar/temporary alias financial account info
   Retrieve player/player character/single-use avatar/temporary alias activity info
   Retrieve player/player character/single-use avatar/temporary alias virtual records
   Retrieve player/player character/single-use avatar/temporary alias appointment history
   Retrieve player/player character/single-use avatar/temporary alias court appointment history
   Retrieve player/player character/single-use avatar/temporary alias penalty ID (1-n)
   Retrieve player/player character/single-use avatar/temporary alias survey ID (1-n)
   Retrieve/receive professional/professional character ID
   Retrieve professional/professional character client criteria
   Calculate player/player character/single-use avatar/temporary alias qualification
   Output qualification score
Force Professional Service if Rules are Broken
   Receive penalty ID
   Retrieve player ID
   Retrieve relevant professional ID (1-n) based on penalty type
   Schedule appointment (1-n) based on penalty type
Halt Play Activity Until Professional Service is Completed
   Retrieve penalty ID
   Retrieve player ID
   Retrieve appointment history ID
   Confirm professional service completed
   Reactivate banned activity ID (1-n)
Client Creates Look of Professional/Professional Character
   Receive player/player character/temporary alias/single-use avatar login info
   Retrieve player/player character/temporary alias/single-use avatar ID
   Confirm player/player character/temporary alias/single-use avatar identity
   Receive professional/professional character name
   Retrieve professional/professional character ID
   Confirm professional/professional character identity
   Retrieve access authorization ID
   Verify access authorization privileges
   Receive visual characteristic attributes
   Receive professional/professional character permission (if applicable)
   Modify professional/professional character virtual attributes

Disputes
Register Dispute
   Receive disputant info
   Retrieve disputant player/player character/temporary alias/single-use avatar/professional/professional character ID
   Confirm disputant player/player character/temporary alias/single-use avatar/professional/professional character identity
   Receive dispute application
   Receive appointment start date/time
   Receive appointment end date/time
   Retrieve appointment ID (1-n)
   Receive player/player character/temporary alias/single-use avatar/professional/professional character info
   Retrieve player/player character/temporary alias/single-use avatar/professional/professional character ID
   Confirm player/player character/temporary alias/single-use avatar/professional/professional character identity
   Calculate fees (if applicable)
   Retrieve fee ID
   Calculate taxes (if applicable)
   Deposit funds in tax accounts (if applicable)
   Deposit funds in game server and/or other accounts (if applicable)
   Retrieve player/player character/temporary alias/single-use avatar/professional/professional character financial account info
   Generate invoice and/or deduct funds from player/player character/temporary alias/single-use avatar/professional/professional character financial account(s)
   Generate dispute ID
   Generate court appointment (if applicable)
   Alert involved disputants
Resolve Dispute
   Receive dispute ID
   Retrieve player/player character/temporary alias/single-use avatar ID (1-n)
   Retrieve professional/professional character ID (1-n)
   Receive textual and/or audio and/or video and/or other testimony from disputants
   Retrieve appointment ID (1-n) (if applicable)
   Retrieve appointment history ID (1-n) (if applicable)
   Retrieve query ID (1-n) (if applicable)
   Retrieve meeting ID (1-n) (if applicable)
   Retrieve virtual record ID (1-n) (if applicable)
   Retrieve prescription ID (1-n) (if applicable)
   Retrieve fee ID (1-n) (if applicable)
   Retrieve invoice ID (1-n) (if applicable)
   Retrieve subscription ID (1-n) (if applicable)
   Retrieve prepaid code ID (1-n) (if applicable)
   Retrieve service coupon ID (1-n) (if applicable)
   Retrieve contract ID (1-n) (if applicable)
   Retrieve survey ID (1-n) (if applicable)
   Retrieve professional license ID (1-n) (if applicable)
   Retrieve professional permit ID (1-n) (if applicable)
   Retrieve professional certification ID (1-n) (if applicable)
   Retrieve certifying panel ID (1-n) (if applicable)
   Retrieve referral ID (1-n) (if applicable)
   Retrieve reference ID (1-n) (if applicable)
   Retrieve advertisement ID (1-n) (if applicable)
   Retrieve access authorization ID (1-n) (if applicable)
   Retrieve jurisdiction ID (1-n) (if applicable)
   Retrieve rule ID (1-n) (if applicable)
   Retrieve law/regulation ID (1-n) (if applicable)
   Receive court decision
   Alert disputants to court decision
   Retrieve fee ID (1-n) (if applicable)
   Retrieve insurance ID (1-n) (if applicable)
   Determine insurance coverage (if applicable)
   Calculate taxes (if applicable)
   Determine disputant financial account info
   Generate invoice and/or deduct funds from disputant financial account(s) (if applicable)
   Deposit funds in tax accounts (if applicable)
   Deposit funds in licensing and/or certifying agency account(s) (if applicable)
Create Dispute Session
   Receive dispute ID
   Retrieve player/player character/temporary alias/single-use avatar ID (1-n)
   Retrieve professional/professional character ID (1-n)
   Receive textual and/or audio and/or video and/or other testimony from disputants
   Retrieve appointment ID (1-n) (if applicable)
   Retrieve appointment history ID (1-n) (if applicable)
   Retrieve query ID (1-n) (if applicable)
   Retrieve meeting ID (1-n) (if applicable)
   Retrieve virtual record ID (1-n) (if applicable)
   Retrieve prescription ID (1-n) (if applicable)
   Retrieve fee ID (1-n) (if applicable)
   Retrieve invoice ID (1-n) (if applicable)
   Retrieve subscription ID (1-n) (if applicable)
   Retrieve prepaid code ID (1-n) (if applicable)
   Retrieve service coupon ID (1-n) (if applicable)
   Retrieve contract ID (1-n) (if applicable)
   Retrieve survey ID (1-n) (if applicable)
   Retrieve professional license ID (1-n) (if applicable)
   Retrieve professional permit ID (1-n) (if applicable)
   Retrieve professional certification ID (1-n) (if applicable)
   Retrieve certifying panel ID (1-n) (if applicable)
   Retrieve referral ID (1-n) (if applicable)
   Retrieve reference ID (1-n) (if applicable)
   Retrieve advertisement ID (1-n) (if applicable)
   Retrieve access authorization ID (1-n) (if applicable)
   Retrieve jurisdiction ID (I-n) (if applicable)
   Retrieve rule ID (1-n) (if applicable)
   Retrieve law/regulation ID (1-n) (if applicable)
   Generate court appointment ID
   Alert disputants to court appointment
   Retrieve fee ID (1-n) (if applicable)
   Retrieve insurance ID (1-n) (if applicable)
   Determine insurance coverage (if applicable)
   Calculate taxes (if applicable)
   Determine disputant financial account info
   Generate invoice and/or deduct funds from disputant financial account(s) (if applicable)
   Deposit funds in tax accounts (if applicable)
   Deposit funds in licensing and/or certifying agency account(s) (if applicable)
Create Insurance Policy
   Receive insurance policy application
   Retrieve player/player character/professional/professional character ID
   Retrieve profession ID (1-n) (if applicable)
   Retrieve license ID (1-n) (if applicable)
   Retrieve rating ID (1-n) (if applicable)
   Retrieve certification ID (1-n) (if applicable)
   Retrieve skill ID (1-n) (if applicable)
   Retrieve game level ID
   Retrieve financial account info
   Generate insurance application score
   Retrieve fee ID (1-n)
   Calculate taxes (if applicable)
   Retrieve financial account info
   Generate invoice and/or deduct funds from player/player character/professional/professional character financial account(s)
   Deposit funds in tax accounts (if applicable)
   Deposit funds in licensing and/or certifying agency account(s) (if applicable)
   Generate insurance policy ID
Renew Insurance Policy
   Receive insurance policy application
   Retrieve player/player character/professional/professional character ID
   Retrieve current insurance policy ID (1-n)
   Retrieve profession ID (1-n) (if applicable)
   Retrieve license ID (1-n) (if applicable)
   Retrieve rating ID (1-n) (if applicable)
   Retrieve certification ID (1-n) (if applicable)
   Retrieve skill ID (1-n) (if applicable)
   Retrieve game level ID
   Retrieve financial account info
   Generate insurance application renewal score
   Retrieve fee ID (1-n)
   Calculate taxes (if applicable)
   Retrieve financial account info
   Generate invoice and/or deduct funds from player/player character/professional/professional character financial account(s)
   Deposit funds in tax accounts (if applicable)
   Deposit funds in licensing and/or certifying agency account(s) (if applicable)
   Generate insurance policy ID
Create/Update Professional Calendar
   Receive professional/professional character login
   Retrieve professional/professional character ID
   Retrieve access authorization ID
   Confirm professional/professional character access authorization
   Receive appointment start date/time
   Receive appointment end date/time
   Receive appointment comments/notes
   Retrieve/generate appointment ID
   Receive player/player character/temporary alias/single-use avatar ID (1-n) (if applicable)
   Generate calendar ID/update calendar
View Professional Calendar
   Receive professional/professional character name (if applicable)
   Retrieve professional/professional character ID (if applicable)
   Receive profession type (if applicable)
   Retrieve profession ID (if applicable)
   Receive start date/time
   Receive end date/time
   Receive player/player character/single-use avatar/temporary alias/professional/professional character login (if applicable)
   Retrieve player/player character/single-use avatar/temporary alias/professional/professional character ID (if applicable)
   Retrieve access authorization ID (if applicable)
   Confirm player/player character/single-use avatar/temporary alias/professional/professional character access authorization (if applicable)
   Retrieve calendar ID
   Output calendar

Waiting Room
Client Assigned to Waiting Room
   Receive player/player character/temporary alias/single-use avatar ID
   Receive appointment ID
   Retrieve professional/professional character ID
   Retrieve profession ID (1-n)
   Retrieve relevant virtual waiting room ID (1-n)
   Calculate virtual waiting room occupancy
   Retrieve player/player character/temporary alias/single-use avatar preferences
   Retrieve appointment urgency rank
   Retrieve appointment notoriety rank (1-x)
   Retrieve appointment sensitivity rank (1-x)
   Calculate best available waiting room
   Assign player/player character/single-use avatar/temporary alias to virtual waiting room
Client Creates Waiting Room Appearance
   Receive player/player character/temporary alias/single-use avatar login (if applicable)
   Retrieve player/player character/temporary alias/single-use avatar ID (if applicable)
   Retrieve access authorization ID (if applicable)
   Confirm player/player character/temporary alias/single-use avatar access authorization (if applicable)
   Receive waiting room dimensions
   Receive waiting room characteristics
   Generate waiting room appearance ID
   Retrieve waiting room ID
   Output modified waiting room appearance
Professional Creates Appearance of Office
   Receive professional/professional character login (if applicable)
   Retrieve professional/professional character ID (if applicable)
   Retrieve access authorization ID (if applicable)
   Confirm professional/professional character access authorization (if applicable)
   Receive office dimensions
   Receive office characteristics
   Generate office appearance ID
   Retrieve office ID
   Output modified office appearance
Professional Creates Appearance of Waiting Room
   Receive professional/professional character login (if applicable)
   Retrieve professional/professional character ID (if applicable)
   Retrieve access authorization ID (if applicable)
   Confirm professional/professional character access authorization (if applicable)
   Receive waiting room dimensions
   Receive waiting room characteristics
   Generate waiting room appearance ID
   Retrieve waiting room ID
   Output modified waiting room appearance

Surveys/Contracts
Create Survey Template
   Receive professional/professional character login
   Retrieve professional/professional character ID
   Confirm professional/professional character identity
   Receive survey template questions
   Receive survey template name
   Generate survey template ID
Complete Survey
   Receive player/player character/temporary alias/single-use avatar info
   Retrieve player/player character/temporary alias/single-use avatar ID
   Retrieve survey template ID
   Retrieve survey template questions
   Receive survey answers
   Receive survey virtual signature (if applicable)
   Generate survey ID
Retrieve Survey Answers
   Receive professional/professional character login
   Retrieve professional/professional character ID
   Receive survey ID
   Verify access authorization
   Output survey contents
Create Contract
   Receive player/player character/single-use avatar/temporary alias ID
   Receive professional/professional character ID
   Retrieve contract template name
   Retrieve contract template ID
   Receive contract template modifications
   Receive virtual signatures
   Generate contract ID
   Generate escrow ID (if applicable)

Meetings
Create Meeting
   Receive virtual meeting start date/time
   Receive virtual meeting end date/time
   Receive virtual meeting virtual location
   Receive office appearance info
   Receive waiting room appearance info
   Receive participant info (1-n)
   Calculate costs
   Generate fee ID
   Calculate taxes
   Retrieve player/player character/temporary alias/single-use avatar/professional/professional character financial account info
   Bill player/player character/temporary alias/single-use avatar/professional/professional character and/or deduct funds from player/player character/temporary alias/single-use avatar/professional/professional character financial account
   Deposit funds in tax accounts (if applicable)
   Deposit funds in game server and/or other accounts (if applicable)
   Generate virtual meeting ID
   Generate virtual meeting reservation
   Output virtual meeting notification to participants
   Output virtual meeting reminder(s) and/or alert(s) (if applicable)
Invite People to Meeting
   Receive player/player character/temporary alias/single-use avatar/professional/professional character info
   Retrieve player/player character/temporary alias/single-use avatar/professional/professional character ID (1-n)
   Receive virtual meeting info
   Retrieve virtual meeting ID
   Retrieve access authorization ID (1-n)
   Generate virtual meeting invitation (with applicable access authorization codes)
   Output virtual meeting invitation to invitees
   Output virtual meeting reminder(s) and/or alert(s) (if applicable)
Create Meeting Log
   Receive first participant entry
   Retrieve virtual meeting ID
   Retrieve appointment ID
   Retrieve camera ID (1-n)
   Begin textual/audio/video recording
   Receive meeting end date/time and/or last participant exit
   Stop textual/audio/video recording
   Generate meeting log
Provide Access to Meeting Log
   Receive player/player character/temporary alias/single-use avatar/professional/professional character personal info
   Retrieve player/player character/temporary alias/single-use avatar/professional/professional character ID
   Receive meeting ID
   Receive player/player character/temporary alias/single-use avatar/professional/professional character access authorization code
   Verify access authorization
   Receive secondary player/player character/temporary alias/single-use avatar/professional/professional character info
   Generate access authorization code(s)
   Output access authorization code(s) to secondary player/player character/temporary alias/single-use avatar/professional/professional character(s)
Provide Legal Name for Premium Service
   Receive player login info
   Retrieve player ID
   Retrieve access authorization ID
   Confirm player access authorization
   Output notification of premium service qualification
Prescribe Medication
   Receive professional/professional character info
   Retrieve professional/professional character ID
   Receive player/player character/temporary alias/single-use avatar info
   Retrieve player/player character/temporary alias/single-use avatar ID
   Confirm player/player character/temporary alias/single-use avatar identity
   Receive prescription information
   Receive prescription start date/time
   Receive prescription end date/time
   Verify professional/professional character prescription certification
   Generate prescription ID
   Alert player/player character/temporary alias/single-use avator to prescription
Track real world credentials using virtual world registration
   Receive licensor login (if applicable)
   Retrieve licensor ID (if applicable)
   Retrieve access authorization ID (if applicable)
   Confirm licensor access authorization (if applicable)
   Receive profession name (if applicable)
   Retrieve profession ID (if applicable)
   Receive professional license name (if applicable)
   Retrieve professional license ID (if applicable)
   Receive professional permit name (if applicable)
   Retrieve professional permit ID (if applicable)
   Receive professional/professional character name
   Retrieve professional/professional character ID
   Retrieve professional ranking score
   Output report
Pre-Qualify Professional for Real World Certification
   Receive professional/professional character ID
   Retrieve professional/professional character calendar ID
   Calculate total hours of service performed
   Retrieve professional ranking score
   Retrieve professional referrals
   Retrieve professional pre-qualification criteria
   Generate professional pre-qualification report
   Alert licensor and/or certification panel

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps.

The invention is described with reference to several embodiments. However, the invention is not limited to the embodiments disclosed, and those of ordinary skill in the art will recognize that the invention is readily applicable to many other diverse embodiments and applications. Accordingly, the subject matter of the present disclosure includes all novel and nonobvious combinations and subcombinations of the various systems, methods and configurations, and other features, functions, and/or properties disclosed herein.

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. §1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Thus a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth□, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing a virtual environment wherein players are able to interact with each other and the environment via avatars;
creating a single-use avatar for a player, wherein use of the single-use avatar by the player is limited by a factor;
representing the player in the game environment with the single-use avatar so that the player's identity is concealed from any player that interacts with the single-use avatar.

2. The method of claim 1 wherein the factor is the passage of a given period of time.

3. The method of claim 2 wherein once the given period of time is expired, the single-use avatar is no longer available to the player.

4. The method of claim 1 wherein the factor is the existence of an in-game condition.

5. The method of claim 4 wherein use of the single-use avatar by the player is limited by location.

6. The method of claim 5 wherein the location is a place of business.

7. The method of claim 4 wherein use of the single-use avatar by the player is limited by an in-game occurrence.

8. The method of claim 5 wherein the occurrence is an encounter with a business associate.

9. The method of claim 6 wherein the business associate is a client.

10. The method of claim 6 wherein the business associate is a patient.

11. The method of claim 4 wherein once the in-game condition no longer exists, the single use avatar is no longer available to the player.

12. The method of claim 1 wherein the single-use avatar is provided automatically to the player.

13. The method of claim 1 wherein the single-use avatar is provided to the player at the player's request.

14. A method comprising:
providing a virtual environment wherein players interact with each other and the environment via avatars;
receiving a request from a player to receive a service from a virtual professional;
adding the player to a queue of players waiting to receive services from the virtual professional; and
notifying the player when the virtual professional is available to deliver the service to the player.

15. The method of claim 14 further comprising offering the player the option to pay a fee in return for being moved up in the queue.

16. The method of claim 14 further comprising providing a waiting room environment with which the player may interact while waiting for the virtual professional.

17. The method of claim 16 wherein the look and feel of the waiting room can be customized by each player in the waiting room.

18. The method of claim 14 further comprising providing a single-use avatar to the virtual professional for use while the virtual professional interacts with the player.

19. The method of claim 18 wherein the look and feel of the virtual professional's single-use avatar is customizable by the player.

20. The method of claim 14 further comprising providing a single-use avatar to the player for use while the player interacts with the virtual professional.
